(19) United States
(12) Patent Application Publication
(10) Pub. No.: US 2021/0350357 A1
(43) Pub. Date: Nov. 11, 2021

(54) SYSTEM AND METHOD FOR PARTICIPANT VETTING AND RESOURCE RESPONSES

(71) Applicant: INTELLI NETWORK CORPORATION, Calgary (CA)

(72) Inventor: Kamea Aloha LAFONTAINE, Calgary Alberta (CA)

(21) Appl. No.: 17/243,790

(22) Filed: Apr. 29, 2021

Related U.S. Application Data
(60) Provisional application No. 63/017,811, filed on Apr. 30, 2020.
(60) Provisional application No. 63/133,424, filed on Jan. 4, 2021.

(51) Int. Cl. G06Q 20/36; G06Q 20/38; G06Q 20/40; G06N 3/08

(52) U.S. Cl. CPC G06Q 20/3674; G06N 3/08; G06Q 20/401; G06Q 20/389

(57) ABSTRACT

A system and method for analyzing input crowdsourced information, preferably according to an AI (artificial intelligence) model, with the addition of vetting of the participants. The AI model may include machine learning and/or deep learning algorithms. The crowdsource information may be obtained in any suitable manner, including but not limited to written text, such as a document, or audio information. The audio information is preferably converted to text before analysis. The participants may be vetted in a variety of ways, including but not limited to verified identification (ID), verified skills, verified affiliation, verified credentials and also optionally verification through the addition of a blockchain-based identity.

### FIELD OF THE INVENTION

The present invention provides a system and method for analyzing crowdsourced input information, and in particular, to such a system and method for analyzing input crowdsourced information from vetted participants.

### BACKGROUND OF THE INVENTION

Analysis of crowdsourced information is a difficult problem to solve. Currently such analysis largely relies on manual labor to review the crowdsourced information. This is clearly impractical as a large scale solution.

For example, for reporting crimes and tips related to crimes, crowdsourced information can be very valuable. But simply gathering large amounts of tips is not useful, as the information is of widely varying quality and may include errors or biased information, which further reduces its utility. Currently the police need to review crime tips manually, which requires many person hours and makes it more difficult to fully use all received information.

Safety is a major concern for people living in a civilized society. People make life and business decisions based on reported crime and reputation of an area. For example, a person may extend his or her travel time to avoid traveling through an area of high crime (e.g., robbery, vehicle theft). Or, a business may not service a particular area because of concern for its employee safety.

Prior to visiting a specific area, people often conduct online research about crime reports of the specific area. However, these reports are often unreliable because people under-report crimes, if they reported the crime at all. For example, the public reports less than one-third of all crime to the police. Moreover, neighborhood-watch programs are on the decline, which translates into less crime reported by the public.

In addition, people may fear the social backlash of reporting a crime. By reporting a crime, the victim does not receive any anonymity and might be ridiculed or ostracized by society. For example, in sexual assault cases, the victim might be called a liar or publicly shamed or humiliated if the sexual assault case involves a high-profile public figure.

Sharing crime information online is dangerous, especially if authorities have not apprehended the person who committed the crime. By sharing certain information online, the victim might unwilling invite a second attack (retaliation) by the perpetrator of the original crime or by another person.

With all of the above issues, the crime data might not be publicly available because authorities are not tracking crime statistics or have declined to share the data with the public. When the crime data is publicly available, the data might not be easily accessible or may lack sufficient detail.

On the other hand, many times the police may not be best positioned to respond. For example, a loud party or other situations may be better handled through community resources. The police also may not be able to help for natural disasters or health situations. Furthermore, some situations may be handled sufficiently well through information provision.

### BRIEF SUMMARY OF THE INVENTION

The present invention, in at least some embodiments, relates to a system and method for analyzing input crowdsourced information, preferably according to an AI (artificial intelligence) model, with the addition of vetting of the participants, including vetting user credentials and optionally also user qualification information. The AI model may include machine learning and/or deep learning algorithms. The crowdsource information may be obtained in any suitable manner, including but not limited to written text, such as a document, or audio information. The audio information is preferably converted to text before analysis. The participants may be vetted in a variety of ways, including but not limited to verified identification (ID), verified skills, verified affiliation, verified credentials and also optionally verification through the addition of a blockchain-based identity.

By “document”, it is meant any text featuring a plurality of words. The algorithms described herein may be generalized beyond human language texts to any material that is susceptible to tokenization, such that the material may be decomposed to a plurality of features.

The crowdsourced information may be any type of information that can be gathered from a plurality of user-based sources. By “user-based sources” it is meant information that is provided by individuals. Such information may be based upon sensor data, data gathered from automated measurement devices and the like, but is preferably then provided by individual users of an app or other software as described herein.

Preferably the crowdsourced information includes information that relates to a person, that impinges upon an individual or a property of that individual, or that is specifically directed toward a person. Non-limiting examples of such crowdsourced types of information include crime tips, medical diagnostics, valuation of personal property (such as a house) and evaluation of candidates for a job or for a placement at a university.

Preferably the process for evaluating the information includes removing any emotional content or bias from the crowdsourced information. For example, crime relates to people personally—whether to their body or their property. Therefore, crime tips impinge directly on people's sense of themselves and their personal space. Desensationalizing this information is preferred to prevent errors of judgement. For these types of information, removing any emotionally laden content is important to at least reduce bias.

Preferably, the evaluation process also includes determining a gradient of severity of the information, and specifically of the situation that is reported with the information. For example and without limitation, for crime, there is typically an unspoken threshold, gradient or severity in a community that determines when a crime would be reported. For a crime that is not considered to be sufficiently serious to call the police, the app or other software for crowdsourcing the information may be used to obtain the crime tip, thereby providing more intelligence about crime than would otherwise be available.

Such crowdsourcing may be used to find the small, early beginnings of crime and map the trends and reports for the community.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions.

Software (e.g., an application, computer instructions) which is configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions—which can be a set of instructions, an application, software—which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1A shows an exemplary illustrative non-limiting schematic block diagram of a system for processing incoming information by using various types of artificial intelligence (AI) techniques including but not limited to machine learning and deep learning;

FIGS. 1B and 1C illustrate a system for creating and providing resource requirement intelligence based on crowdsourced information, in accordance with one or more implementations of the present invention;

FIG. 2 shows a non-limiting exemplary method for analyzing received information from a plurality of users through a crowdsourcing model of receiving user information in a method that preferably also relates to artificial intelligence;

FIGS. 3A-3C relate to non-limiting exemplary systems and flows for providing information to an artificial intelligence system with specific models employed and then analyzing it;

FIGS. 4A-4C relate to a non-limiting exemplary flow for analyzing information by an artificial intelligence engine as described herein;

FIG. 5 relates to a non-limiting exemplary flow for training the AI engine as described herein;

FIG. 6 relates to a non-limiting exemplary method for obtaining training data for training the neural net models as described herein;

FIG. 7 relates to a non-limiting exemplary method for evaluating a source for data for training and analysis as described herein;

FIG. 8 relates to a non-limiting exemplary method for performing context evaluation for data;

FIG. 9 relates to a non-limiting exemplary method for connection evaluation for data;

FIG. 10 relates to a non-limiting exemplary method for source reliability evaluation;

FIG. 11 relates to a non-limiting exemplary method for a data challenge process;

FIG. 12 relates to a non-limiting exemplary method for a reporting assistance process;

FIG. 13 illustrates a method of securing the user wallet through a verifiable means of connecting wallet seeds in an obfuscated way with a particular known user identity;

FIG. 14 illustrates a method for receiving community resource related information and/or requests submitted by users, in accordance with one or more implementations of the present invention;

FIG. 15 shows a non-limiting, exemplary system for intelligent escalation response (IERS), which may be implemented for example as described with regard to the functions of FIG. 4C;

FIG. 16 shows non-limiting examples of different situations and the levels of resources to which these situations may be matched, according to the content of the situation itself and the report made by the end user;

FIG. 17 shows a non-limiting example of another system for intelligent escalation;

FIGS. 18A and 18B related to non-limiting, exemplary methods for user verification;

FIG. 19 relates to a non-limiting, exemplary method for user role verification;

FIG. 20 relates to a non-limiting, exemplary method for publisher operation with verification;

FIG. 21 shows a non-limiting, exemplary screenshot for news publication;

FIG. 22 relates to a non-limiting, exemplary method for challenging a report by a publisher or other corporate citizen;

FIG. 23 relates to a non-limiting, exemplary method for user verification and credentialing;

FIG. 24 relates to a non-limiting, exemplary system for global credentials;

FIG. 25 relates to a non-limiting, exemplary method for map creation; and

FIGS. 26A and 26B relate to two non-limiting examples of maps, created according to the method of FIG. 25.

### DESCRIPTION OF AT LEAST SOME EMBODIMENTS

The present invention, in at least some embodiments, relates to a system and method for analyzing input crowdsourced information, preferably according to an AI (artificial intelligence) model, to determine which community resource(s) should be applied. The AI model may include machine learning and/or deep learning algorithms. The crowdsource information may be obtained in any suitable manner, including but not limited to written text, such as a document, or audio information. The audio information is preferably converted to text before analysis.

By “document”, it is meant any text featuring a plurality of words. The algorithms described herein may be generalized beyond human language texts to any material that is susceptible to tokenization, such that the material may be decomposed to a plurality of features.

Various methods are known in the art for tokenization. For example and without limitation, a method for tokenization is described in Laboreiro, G. et al (2010, Tokenizing micro-blogging messages using a text classification approach, in ‘Proceedings of the fourth workshop on Analytics for noisy unstructured text data’, ACM, pp. 81-88).

Once the document has been broken down into tokens, optionally less relevant or noisy data is removed, for example to remove punctuation and stop words. A non-limiting method to remove such noise from tokenized text data is described in Heidarian (2011, Multi-clustering users in twitter dataset, in ‘International Conference on Software Technology and Engineering, 3rd (ICSTE 2011)’, ASME Press). Stemming may also be applied to the tokenized material, to further reduce the dimensionality of the document, as described for example in Porter (1980, ‘An algorithm for suffix stripping’, Program: electronic library and information systems 14(3), 130-137).

The tokens may then be fed to an algorithm for natural language processing (NLP) as described in greater detail below. The tokens may be analyzed for parts of speech and/or for other features which can assist in analysis and interpretation of the meaning of the tokens, as is known in the art.

Alternatively or additionally, the tokens may be sorted into vectors. One method for assembling such vectors is through the Vector Space Model (VSM). Various vector libraries may be used to support various types of vector assembly methods, for example according to OpenGL. The VSM method results in a set of vectors on which addition and scalar multiplication can be applied, as described by Salton & Buckley (1988, ‘Term-weighting approaches in automatic text retrieval’, Information processing & management 24(5), 513-523).

To overcome a bias that may occur with longer documents, in which terms may appear with greater frequency due to length of the document rather than due to relevance, optionally the vectors are adjusted according to document length. Various non-limiting methods for adjusting the vectors may be applied, such as various types of normalizations, including but not limited to Euclidean normalization (Das et al., 2009, ‘Anonymizing edge-weighted social network graphs’, Computer Science, UC Santa Barbara, Tech. Rep. CS-2009-03); or the TF-IDF Ranking algorithm (Wu et al, 2010, Automatic generation of personalized annotation tags for twitter users, in ‘Human Language Technologies: The 2010 Annual Conference of the North American Chapter of the Association for Computational Linguistics’, Association for Computational Linguistics, pp. 689-692).

One non-limiting example of a specialized NLP algorithm is word2vec, which produces vectors of words from text, known as word embeddings. Word2vec has a disadvantage in that transfer learning is not operative for this algorithm. Rather, the algorithm needs to be trained specifically on the lexicon (group of vocabulary words) that will be needed to analyze the documents.

Optionally the tokens may correspond directly to data components, for use in data analysis as described in greater detail below. The tokens may also be combined to form one or more data components, for example according to the type of information requested. For example, for crime tip or report, a plurality of tokens may be combined to form a data component related to the location of the crime. Preferably such a determination of a direct correspondence or of the need to combine tokens for a data component is determined according to natural language processing.

In describing the novel system and method for creating and providing crime intelligence based on crowdsourced information stored on a blockchain, the provided examples should not be deemed to be exhaustive. While one implementation is described hereto, it is to be understood that other variations are possible without departing from the scope and nature of the present invention.

A blockchain is a distributed database that maintains a list of data records, the security of which is enhanced by the distributed nature of the blockchain. A blockchain typically includes several nodes, which may be one or more systems, machines, computers, databases, data stores or the like operably connected with one another. In some cases, each of the nodes or multiple nodes are maintained by different entities. A blockchain typically works without a central repository or single administrator. One well-known application of a blockchain is the public ledger of transactions for cryptocurrencies such as used in bitcoin. The recorded data records on the blockchain are enforced cryptographically and stored on the nodes of the blockchain.

A blockchain provides numerous advantages over traditional databases. A large number of nodes of a blockchain may reach a consensus regarding the validity of a transaction contained on the transaction ledger. Similarly, when multiple versions of a document or transaction exist on the ledger, multiple nodes can converge on the most up-to-date version of the transaction. For example, in the case of a virtual currency transaction, any node within the blockchain that creates a transaction can determine within a level of certainty whether the transaction can take place and become final by confirming that no conflicting transactions (i.e., the same currency unit has not already been spent) confirmed by the blockchain elsewhere.

The blockchain typically has two primary types of records. The first type is the transaction type, which consists of the actual data stored in the blockchain. The second type is the block type, which are records that confirm when and in what sequence certain transactions became recorded as part of the blockchain. Transactions are created by participants using the blockchain in its normal course of business, for example, when someone sends cryptocurrency to another person), and blocks are created by users known as “miners” who use specialized software/equipment to create blocks. Users of the blockchain create transactions that are passed around to various nodes of the blockchain. A “valid” transaction is one that can be validated based on a set of rules that are defined by the particular system implementing the blockchain.

In some blockchain systems, miners are incentivized to create blocks by a rewards structure that offers a pre-defined per-block reward and/or fees offered within the transactions validated themselves. Thus, when a miner successfully validates a transaction on the blockchain, the miner may receive rewards and/or fees as an incentive to continue creating new blocks.

Preferably, the blockchain(s) that is/are implemented are capable of running code, to facilitate the use of smart contracts. Smart contracts are computer processes that facilitate, verify and/or enforce negotiation and/or performance of a contract between parties. One fundamental purpose of smart contracts is to integrate the practice of contract law and related business practices with electronic commerce protocols between people on the Internet. Smart contracts may leverage a user interface that provides one or more parties or administrators access, which may be restricted at varying levels for different people, to the terms and logic of the contract. Smart contracts typically include logic that emulates contractual clauses that are partially or fully self-executing and/or self-enforcing. Examples of smart contracts are digital rights management (DRM) used for protecting copyrighted works, financial cryptography schemes for financial contracts, admission control schemes, token bucket algorithms, other quality of service mechanisms for assistance in facilitating network service level agreements, person-to-person network mechanisms for ensuring fair contributions of users, and others.

Smart contracts may also be described as pre-written logic (computer code), stored and replicated on a distributed storage platform (e.g. a blockchain), executed/run by a network of computers (which may be the same ones running the blockchain), which can result in ledger updates (cryptocurrency payments, etc).

Smart contract infrastructure can be implemented by replicated asset registries and contract execution using cryptographic hash chains and Byzantine fault tolerant replication. For example, each node in a peer-to-peer network or blockchain distributed network may act as a title registry and escrow, thereby executing changes of ownership and implementing sets of predetermined rules that govern transactions on the network. Each node may also check the work of other nodes and in some cases, as noted above, function as miners or validators.

Not all blockchains can execute all types of smart contracts. For example, Bitcoin cannot currently execute smart contracts. Sidechains, i.e. blockchains connected to Bitcoin's main blockchain could enable smart contract functionality: by having different blockchains running in parallel to Bitcoin, with an ability to jump value between Bitcoin's main chain and the side chains, side chains could be used to execute logic. Smart contracts that are supported by sidechains are contemplated as being included within the blockchain enabled smart contracts that are described below.

For all of these examples, security for the blockchain may optionally and preferably be provided through cryptography, such as public/private key, hash function or digital signature, as is known in the art.

Although the below description centers around trading of cryptocurrencies, it is understood that the systems and methods shown herein would be operative to trade any type of cryptoasset or data on the blockchain.

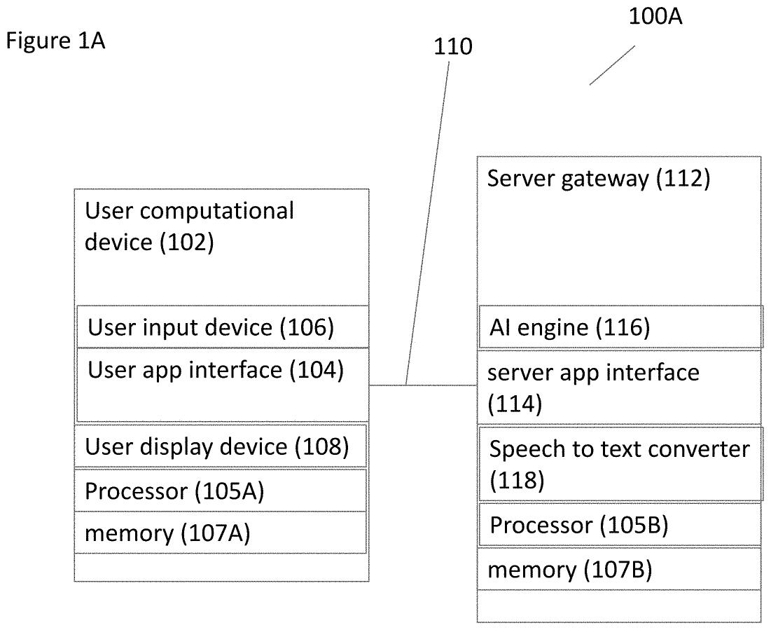

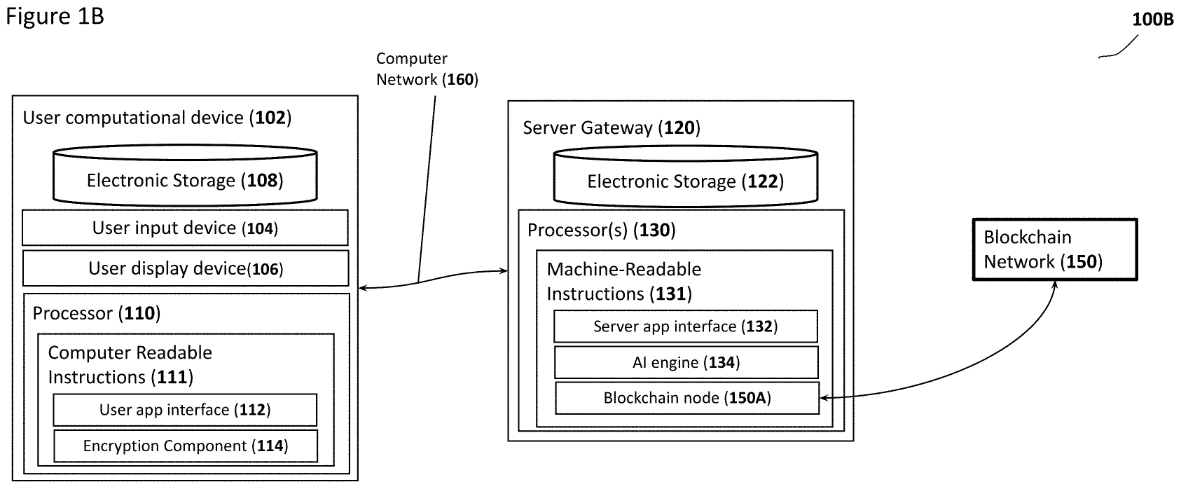

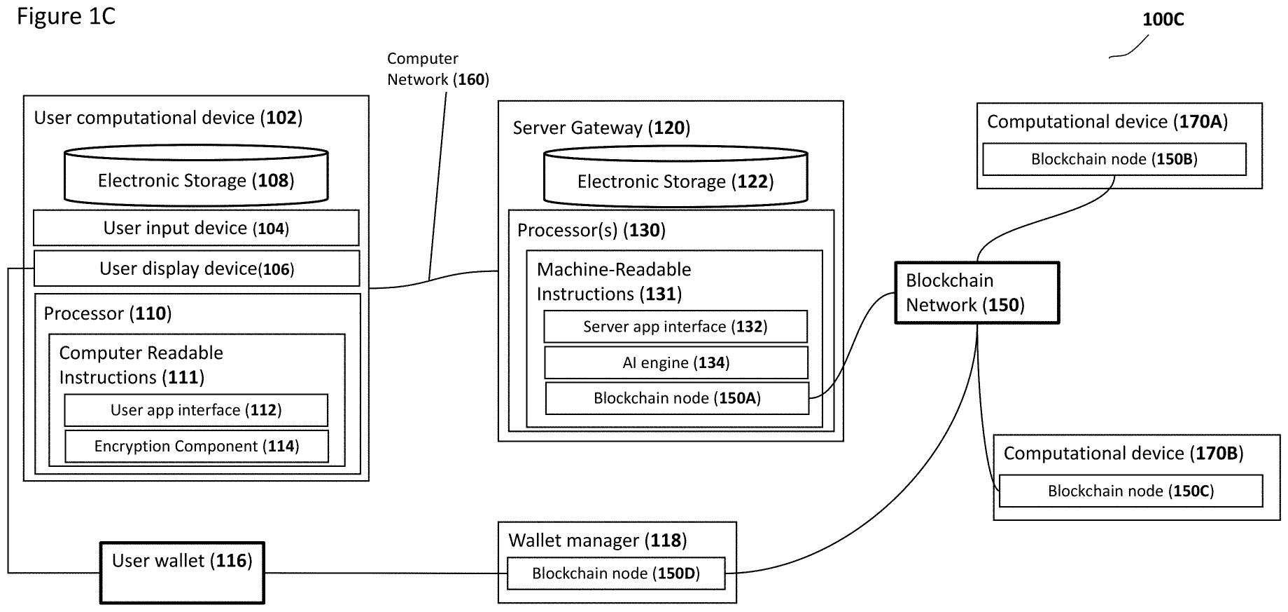

Turning now to the figures, FIG. 1A shows an exemplary illustrative non-limiting schematic block diagram of a system for processing incoming information by using various types of artificial intelligence (AI) techniques including but not limited to machine learning and deep learning. These techniques support resource provision directly (for example, by providing information) or a connection to a further resource (such as a health authority, police or other first responders). Non-limiting examples of such resources include any type of responder resource, such as a first responder for public health and safety, a government agency, an NGO (non-governmental organization), not for profit or other such responding organization, as well as temporary responders (such as businesses, educational, religious or other institutions which may temporarily provide support, for example shelter in case of a natural disaster).

As shown in the system 100A, there is provided a user computational device 102 in communication with the server gateway 112 through a computer network 110 such as the internet for example.

User computational device 102 includes the user input device 106, the user app interface 104, and user display device 108. The user input device 106 may optionally be any type of suitable input device including but not limited to a keyboard, microphone, mouse, or other pointing device and the like. Preferably user input device 106 includes a list, a microphone and a keyboard, mouse, or keyboard mouse combination.

User display device 108 is able to display information to the user for example from user app interface 104. The user operates user app interface 104 to intake information for review by an artificial intelligence engine being operated by server gateway 112. This information is taken in from user app interface 104 through the server app interface 114 and may optionally also include a speech to text converter 118 for converting speech to text. The information analyze range in 116 preferably takes the form of text and may actually take the form of crime tips or tips about a reported or viewed crime.

Preferably AI engine 116 receives a plurality of different tips or other types of information from different users operating different user computational devices 102. In this case, preferably user app device 104 and or user computational device 102 is identified in such a way so as to be able to sort out duplicate tips or reported information, for example by identifying the device itself or by identifying the user through user app interface 104. Such information may also relate to a request by the user through user app interface 104, for example for a community resource as described herein.

User computational device 102 also comprises a processor 105A and a memory 107A. Functions of processor 105A preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as a memory 107A in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, memory 107A is configured for storing a defined native instruction set of codes. Processor 105A is configured to perform a defined set of basic operations in response to receiving a corresponding basic instruction selected from the defined native instruction set of codes stored in memory 107A. For example and without limitation, memory 107A may store a first set of machine codes selected from the native instruction set for receiving information from the user through user app interface 104 and a second set of machine codes selected from the native instruction set for transmitting such information to server 106 as crowdsourced information.

Similarly, server 106 preferably comprises a processor 105B and a memory 107B with related or at least similar functions, including without limitation functions of server 106 as described herein. For example and without limitation, memory 107B may store a first set of machine codes selected from the native instruction set for receiving crowdsourced information from user computational device 102, and a second set of machine codes selected from the native instruction set for executing functions of AI engine 116.

FIG. 1B illustrates a system 100B configured for creating and providing community resource requirement intelligence based on crowdsourced information, in accordance with one or more implementations of the present invention. These community resources may include police, fire or other safety first responders; health first responders, including but not limited to emergency medical personnel, public safety responders, health and safety responders, and other medical and health personnel, as well as temporary resources. This list can also include temporary resources like volunteer funded organizations, NGO's, GO's that are funded during a crisis. This can also include local business and community resources that arise out of a crisis response. This allows for a maximum resource capability directories to be available in the system during the crisis.

In some implementations, the system 100B may include a user computational device 102 and a server gateway 120 that communicates with the user computational device through a computer network 160, such as the internet. (“Server gateway” and “server” are equivalent and may be used interchangeably). The server gateway 120 also communicates with a blockchain network 150. A user may access the system 100B via user computational device 102.

The user computational device 102 features a user input device 104, a user display device 106, an electronic storage 108 (or user memory), and a processor 110 (or user processor). The user computational device 102 may optionally comprise one or more of a desktop computer, laptop, PC, mobile device, cellular telephone, and the like.

The user input device 104 allows a user to interact with the computational device 102. Non-limiting examples of a user input device 104 are a keyboard, mouse, other pointing device, touchscreen, and the like.

The user display device 106 displays information to the user. Non-limiting examples of a user display device 106 are computer monitor, touchscreen, and the like.

The user input device 104 and user display device 106 may optionally be combined to a touchscreen, for example.

The electronic storage 108 may comprise non-transitory storage media that electronically stores information. The electronic storage media of electronic storage 108 may include one or both of system storage that is provided integrally (i.e., substantially non-removable) with a respective component of system 100B and/or removable storage that is removably connected to a respective component of system 100B via, for example, a port (e.g., a USB port, a firewire port, etc.) or a drive (e.g., a disk drive, etc.). The electronic storage 108 may include one or more of optically readable storage media (e.g., optical discs, etc.), magnetically readable storage medium (e.g., flash drive, etc.), and/or other electronically readable storage medium. The electronic storage 108 may include one or more virtual storage resources (e.g., cloud storage, a virtual private network, and/or other virtual storage resources). The electronic storage 108 may store software algorithms, information determine by processor, and/or other information that enables components of a system 100B to function as described herein.

The processor 110 refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

The process 110 is configured to execute readable instructions 111. The computer readable instructions 111 include a user app interface 104, encryption component 114, and/or other components.

The user app interface 104 provides a user interface presented via the user computational device 102. The user app interface 104 may be a graphical user interface (GUI). The user interface may provide information to the user. In some implementations, the user interface may present information associated with one or more transactions. The user interface may receive information from the user. In some implementations, the user interface may receive user instructions to perform a transaction. The user instructions may include a selection of a transaction, a command to perform a transaction, and/or information associated with a transaction.

Referring now to server gateway 120 depicted in FIGS. 1B and 1C, the server gateway 120 communicates with the user computational device 102 and the blockchain network 150. The server gateway 120 facilitates the transfer of information to and from the user and the blockchain. In some implementations, the system 100A may include one or more server gateway 120. The information from user computational device 102 may for example include information about one or more events, which may be related to any type of first responder requiring situation or event, and/or events in which the user has an information request.

The server gateway 120 features an electronic storage 122 (or server memory), one or more processor(s) 130 (or server processor), an artificial intelligence (AI) engine 134, blockchain node 150A, and/or other components. The server gateway 120 may include a plurality of hardware, software, and/or firmware components operating together to provide the functionality attributed herein to server gateway 120.

The electronic storage 122 may comprise non-transitory storage media that electronically stores information. The electronic storage media of electronic storage 122 may include one or both of system storage that is provided integrally (i.e., substantially non-removable) with a respective component of system 100B and/or removable storage that is removably connected to a respective component of system 100B via, for example, a port (e.g., a USB port, a firewire port, etc.) or a drive (e.g., a disk drive, etc.). The electronic storage 122 may include one or more of optically readable storage media (e.g., optical discs, etc.), magnetically readable storage medium (e.g., flash drive, etc.), and/or other electronically readable storage medium. The electronic storage 122 may include one or more virtual storage resources (e.g., cloud storage, a virtual private network, and/or other virtual storage resources). The electronic storage 122 may store software algorithms, information determine by processor, and/or other information that enables components of a system 100B to function as described herein.

The processor 130 may be configured to provide information processing capabilities in server gateway 120. As such, the processor 130 may include a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

The process 130 is configured to execute machine-readable instructions 131. The machine-readable instructions 131 include a server app interface 132, an artificial intelligence (AI) engine 134, a blockchain node 134, and/or other components.

The AI engine 134 may include machine learning and/or deep learning algorithms, which is explained later in greater detail. The AI engine 134 sorts, organizes, and assigned a value to the crime intelligence submitted by users.

The AI engine 134 evaluates the information using based on the following evaluation factors (e.g., time, uniqueness, level of verification, and context). As to the time factor, every blockchain data submission contains a timestamp. This timestamp is used to verify the exact time that a crime intelligence or report was submitted chronologically.

As to the uniqueness factor, the unique nature of each user account is used to validate information. The more detailed the report, and the more times that specific intel occurs over and over again, validates it as being increasingly probable and verified.

Level of verification factor takes into account the type of user providing the information regarding a community situation, such as crime intelligence, and the user's track record of reporting good crime intelligence. The same process may be provided for other types of intelligence or tips as for crime intelligence or tips, for example in regard to data collection, crowdsourced report comparisons, publisher access to “challenge” reports (eg. a journalist uncovers new information), along with analyst and third party data available online. The blend of these local resources may be considered as “local oracles” because they would have the maximum possible context and incentive to tell the truth vs any non-local group, news agency, or government. Optionally, the user could choose to privately report issues, such as requests for health or other information, in which case little or no verification would be required. Verification is required for issues that are reported publicly and for which a reward would be given. Preference is given to large volumes of information in each publicly reported case, because a greater volume is easier to verify and statistically is more likely to be true or correct.

A user may be classified from the following non-limiting list: (1) super users, which are users that have a track record of providing valuable and reliable crime intelligence; and (2) trusted sources (e.g., police, private investigators, and good actors, etc.)

The context factor takes into account the circumstances upon which the incident occurred within the reported crime intelligence. Incidents that occur within high levels of context (e.g., a public shooting, a well-known incident, a geographical area where certain crimes occur more often) is used to help validate and determine the relevance of the crime intelligence reports.

In addition, external data (e.g., social media, private information databases, news/incidence reports) is layered and applied to the crime intelligence reports. The external data provides context for crime intelligence reports and is used to rate the validity score of the reported crime intelligence based on context. For example, if a user submits a report in Barcelona (which is the pickpocket capital of the world) about a pickpocket incident, then the AI engine 134 would rate this reported crime intelligence as being potentially more valid than a less common crime. Another example, if a user submits a report of a sexual assault occurring in winter on a public street out in public during the middle of the day, the AI engine 134 would rate this reported crime intelligence lower than common events like music festivals, where many drunken partiers are more likely to commit these kinds of offences.

The AI engine uses the evaluation factors to create and assign a numerical value to the reported crime intelligence. The numerical value may be determined by using a weighted average. Other means for determining the numerical value may be used, such as sum of values assigned to the evaluation factors.

The blockchain network 150 may include a system, computing platform(s), server(s), electronic storage, external resources(s), processor(s), and/or components associated with the blockchain.

FIG. 1C illustrates a variation of the system shown in FIG. 1B, in accordance with one or more implementations of the present invention. As shown, system 100C features the same elements of system 100B, but contains additional elements. The system 100C comprises a user computational device 102, a user wallet 116, a wallet manager 118, a server gateway 120, blockchain network 150, and computational devices 170A and 170B.

The user wallet 116 is in communication with the user computational device 102. The user wallet 116 is a holding software operated by computational device or platform which would hold or possess the crypto currency owned by the user and would store them in a secure manner. The use of wallet 116 in this example is shown as being managed by the wallet manager 118, operating block chain node 150D. Again, different blockchains would actually be operated for a purchase to occur, but in this case, what is shown is that wallet manager 118 also retains a complete copy of the blockchain by operating blockchain node 150D. In this non-limiting example, the user wallet 116 may optionally be located on a user computational device 102 and may simply be referred to by wallet manager 118 and/or may also be located in an off-site location, and for example, may be located in a server, a server farm, operated by or controlled by a wallet manager 118.

In this non-limiting example, then, the server gateway 120 would either verify that the user had the cryptocurrency available for purchase in user wallet 116, for example through direct communication with wallet manager 118 either directly, buy a computer-to-computer communication, which is not shown, alternatively, by executing a smart contract on the blockchain. If the server gateway 120 were to invoke a smart contract for purchase of crime intelligence data, then, again, this could be written onto the blockchain, such that the wallet manager 118 would then know that the user had used the cryptocurrency in the user wallet 116.

The blockchain network 150 is made of numerous computational devices operating as blockchain nodes. For illustration purposes, only computational devices 170A and 170B are shown, in addition to the server gateway 120, as part of the blockchain network 150 although the blockchain network 150 contains many more computational devices operating as blockchain nodes.

The computational device 170A operates a blockchain node 150B, and a computational device 170B operates a blockchain node 150C. Each such computational device comprises an electronic storage, which is not shown, for storing information regarding the blockchain. In this non-limiting example, blockchain nodes 150A, B, and C belong to a single blockchain, which may be any type of blockchain, as described herein. However, optionally, server gateway 112 may operate with or otherwise be in communication with different blockchains operating according to different protocols.

Blockchain nodes 150A, B, and C are a small sample of the blockchain nodes on the blockchain network 150. Although these nodes appear to be communicating in operation of the blockchain network 150, each computational device retains a complete copy of the blockchain. Optionally, if the blockchain were divided, then each computational device could perhaps retain only a portion of the blockchain.

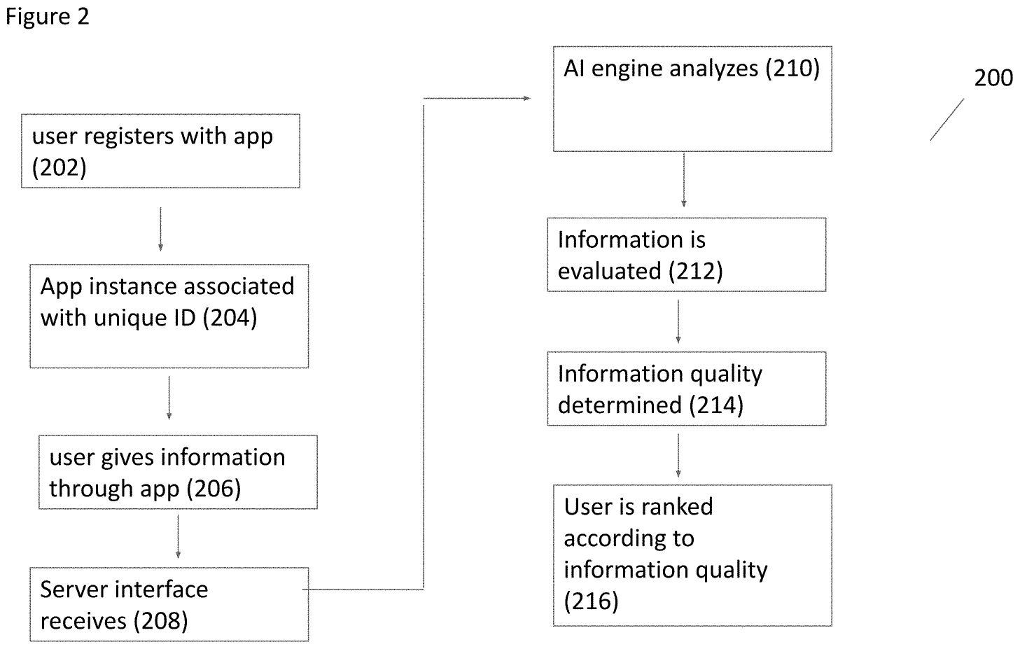

FIG. 2 shows a non-limiting exemplary method for analyzing received information from a plurality of users through a crowdsourcing model of receiving user information in a method that preferably also relates to artificial intelligence. As shown in the method 200, first the user registers with the app in 202. Next, the app instance is associated with a unique ID in 204. This unique ID may be determined according to the specific user, but is preferably also associated with the app instance. Preferably the app is downloaded and operated on a user mobile device as a user computational device, in which case the unique identifier may also be related to the mobile device.

Preferably the unique identifier comprises a DID token on Ethereum network (Decentralized Identifiers). Decentralized Identifiers support verifiable, decentralized digital identities. The DID token supports the use of such identifiers on blockchain, in this case with regard to Ethereum blockchain.

Next, the user gives information through the app in 206, which is received by the server interface at 208. The AI engine analyzes the information in 210 and then evaluates it in 212. After the evaluation, preferably the information quality is determined in 214. The user is then ranked according to information quality in 216. Such a ranking preferably involves comparing information from a plurality of different users and assessing the quality of the information provided by the particular user in regard to the information provided by all users. For example, preferably the process described with regard to FIG. 2 is performed for information received from a plurality of different users, so that the relative quality of the information provided by the users may be determined through ranking. Determining such a relative quality of provided information then enables the users to be ranked according to information quality, which may for example relate to a user reputation ranking (described in greater detail below).

The information preferably relates to events or actions that are important for a community. For example, on crime, fire or other acute, urgent events, the information preferably relates to a report of such an acute, urgent event. On the other hand, events which are chronic or which occur over a longer period of time, such as self-reported symptoms of a virus, are also important. Additionally or alternatively, the user may be requesting information, such as regarding the action to be taken when a member of their household is sick, exhibiting symptoms which may be relevant from a public health perspective.

For example, one paper found that self-reported symptom apps in tracking influenza incidence in Europe were quite helpful and correlated well with actual numbers of patients with those symptoms, who tested positive for influenza (Web-based participatory surveillance of infectious diseases: the Influenzanet participatory surveillance experience; Paolotti et al, European Society of Clinical Infectious Disease, January 2014, Volume 20, Issue 1, Pages 17-21). Briefly, the authors found that the actual tested incidence of influenza, from the European-wide influenza sentinel testing system, correlated well with the self-reported symptoms through apps like De Grote Griepmeting and Influenzanet. Therefore, the self-reporting of such symptoms could be applied to virus spread models.

The models could be judged in aggregate in this case vs individually as the collective data could be also analyzed based on official data. The official data may still be wrong but would provide a benchmark. Optionally, the system may provide a narrower scope of rewards for providing data to model or use to predict future growth curves. Such reporting could also tie into an actual testing center, for example by allowing patients to share their official results using a zero-knowledge proof to confirm their health status, but without providing personal information.

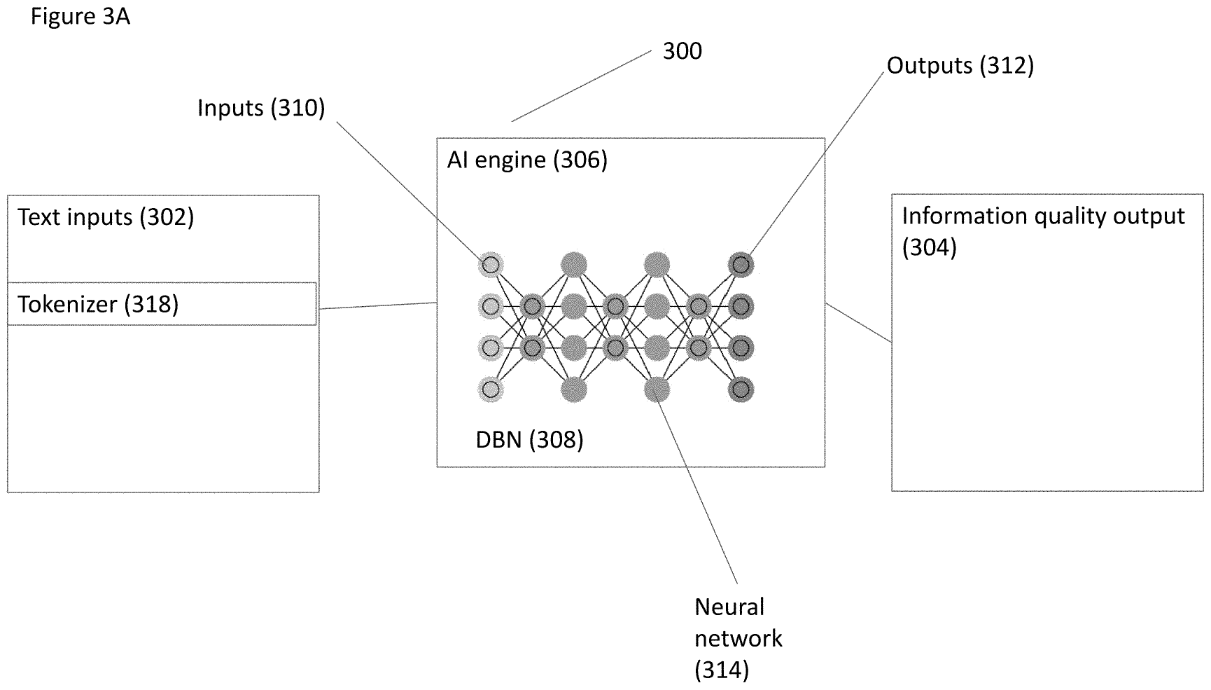

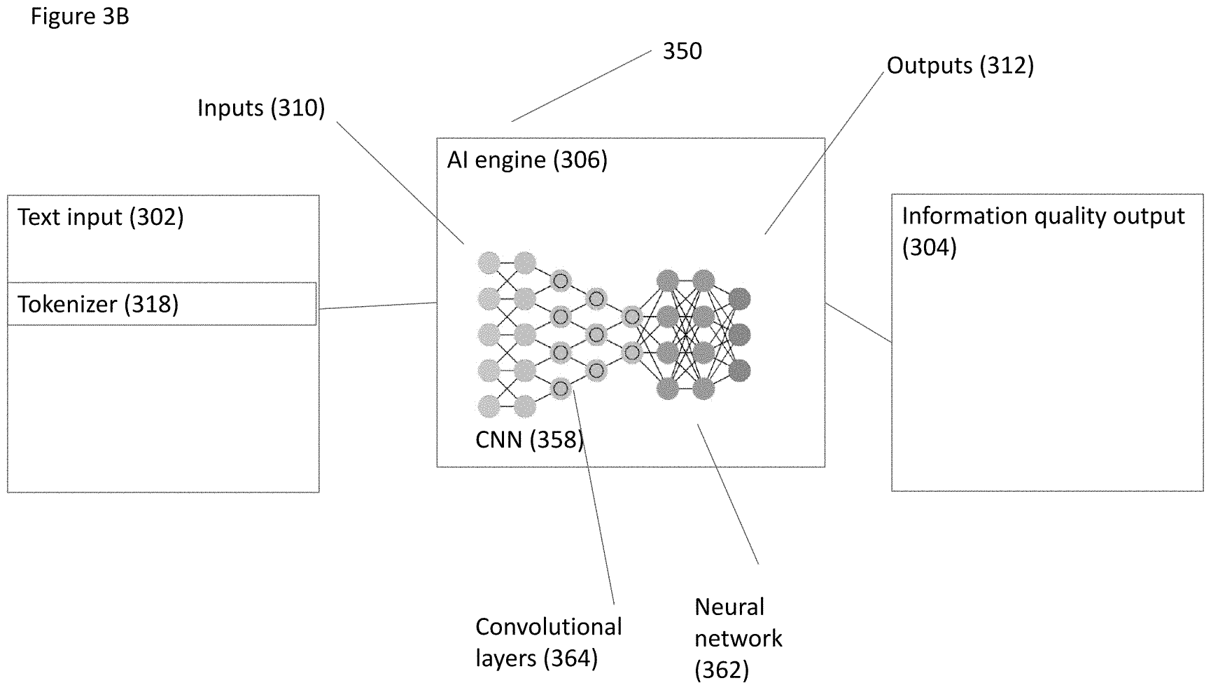

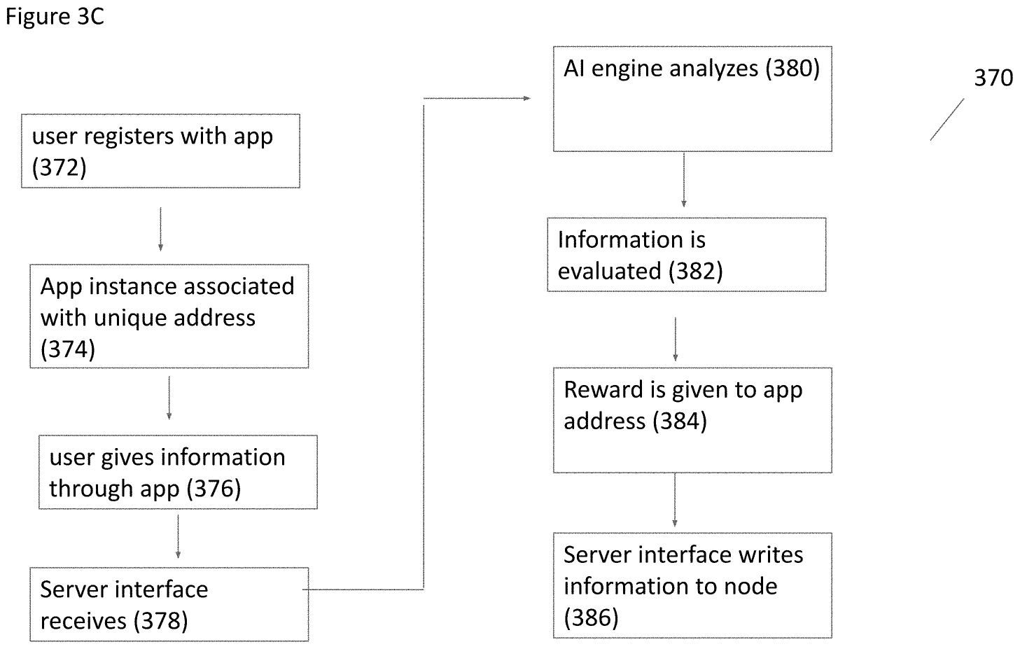

FIGS. 3A-3C relate to non-limiting exemplary systems and flows for providing information regarding the need for a community resource and/or community related information to an artificial intelligence system with specific models employed and then analyzing it. Turning now to FIG. 3A as shown in a system 300, text inputs are preferably provided at 302 and preferably are also analyzed with the tokenizer in 318. A tokenizer is able to break down the text inputs into parts of speech. It is preferably also able to stem the words. For example, running and runs could both be stemmed to the word run. This tokenizer information is then fed into an AI engine in 306 and information quality output is provided by the AI engine in 304. In this non-limiting example, AI engine 306 comprises a DBN (deep belief network) 308. DBN 308 features input neurons 310 and neural network 314 and then outputs 312.

A DBN is a type of neural network composed of multiple layers of latent variables (“hidden units”), with connections between the layers but not between units within each layer.

FIG. 3B relates to a non-limiting exemplary system 350 with similar or the same components as FIG. 3A, except for the neural network model. In this case, a neural network 362 includes convolutional layers 364, neural network 362, and outputs 312. This particular model is embodied in a CNN (convolutional neural network) 358, which is a different model than that shown in FIG. 3A.

A CNN is a type of neural network that features additional separate convolutional layers for feature extraction, in addition to the neural network layers for classification/identification. Overall, the layers are organized in 3 dimensions: width, height and depth. Further, the neurons in one layer do not connect to all the neurons in the next layer but only to a small region of it. Lastly, the final output will be reduced to a single vector of probability scores, organized along the depth dimension. It is often used for audio and image data analysis, but has recently been also used for natural language processing (NLP; see for example Yin et al, Comparative Study of CNN and RNN for Natural Language Processing, arXiv:1702.01923v1 [cs.CL] 7 Feb. 2017).

FIG. 3C illustrates a method 370 for analyzing and evaluating received crime information from a plurality of users through crowdsourcing, in accordance with one or more implementations of the present invention. In Step 372, the method 370 begins with a user registering with the application through the user app interface 112 operating on the user computational device 102. After the user registers with the application, the application instance is associated with a unique address (or unique ID) to the user account (Step 374). This may be the user registering in, but is preferably also associated with the app instance. Preferably, the app is downloaded and operated on a user mobile device as a user computational device, in which case the unique identifier may also be related to the mobile device.

Next, the user then gives information through the user app interface 112 (Step 376). The user app interface 112 communicates with the server app interface 132 operating on the server gateway 120.

The server app interface 132 receives the user's information (Step 378). Next, the AI engine 134 analyzes the information (Step 380) and then evaluates the information (Step 382) using its evaluation criteria (e.g., time, uniqueness, level of verification, and context). The reward (i.e., token) is given to the unique address of the user account (Step 384) based on evaluation of the AI engine 134. Optionally, if the user wishes to obtain information only, the user could report an issue privately rather than publicly. These private reports are preferably treated differently within the system. For example, a private report may not require validation beyond whether the user is truly in need of help or could potentially be spamming the system with unnecessary requests. Follow up questions from the system, for example in the form of a chatbot as described below, preferably still occur to validate the level of response required for the user request. If the request for information would not provide unique information in the system, then there potentially may be a lower or no reward. This would be a basic chat request to connect with a resource.

The server app interface 132 then writes the information to the blockchain node 150A at step 386.

Preferably, the AI engine 134 also removes any emotional content or bias from the crowdsourced information before such information is written to blockchain node 150A. For example, crime relates to people personally—whether to their body or their property. Therefore, crime tips impinge directly on preferred to prevent errors of judgement. For these types of information, removing any emotionally laden content is important to at least reduce bias. Emotional content may also be removed in regard to sickness or other public health information, or information related to natural disasters, as such content may obfuscate the underlying message.

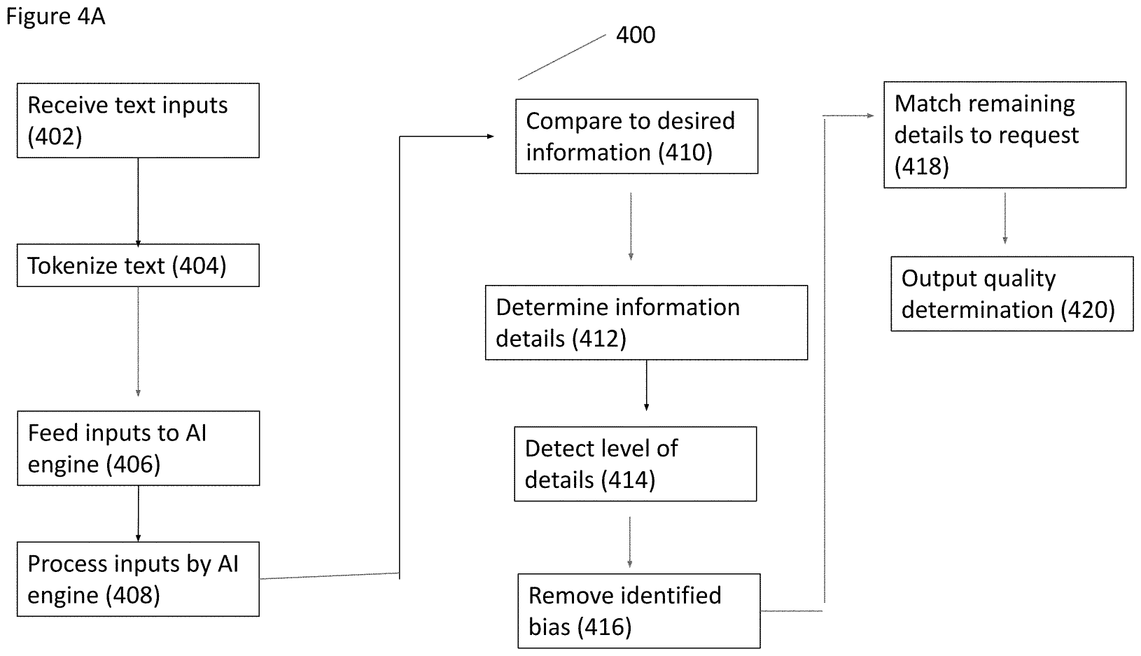

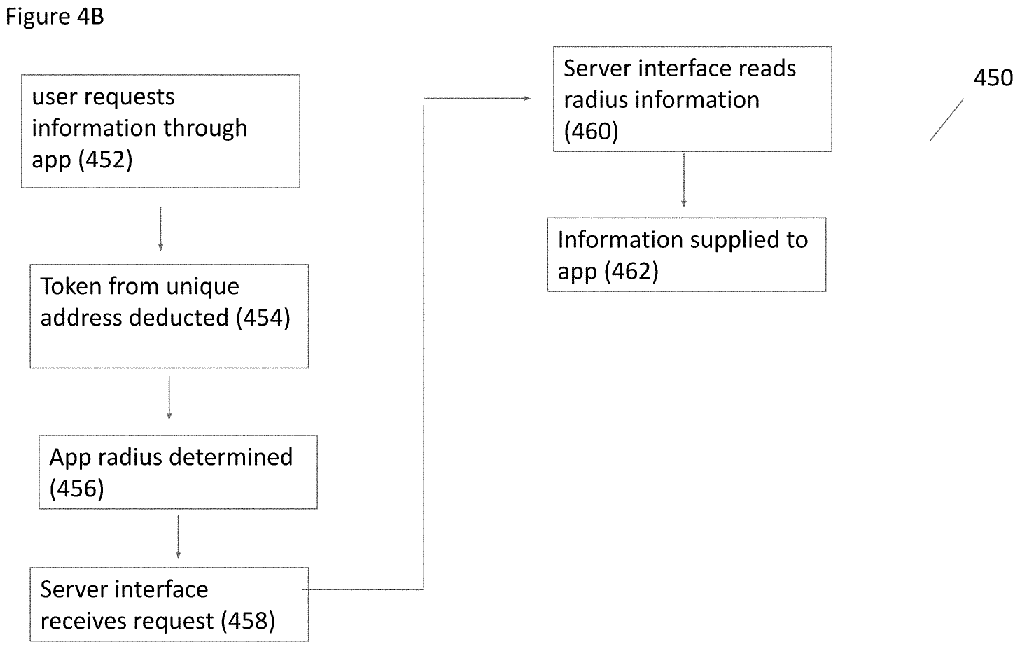

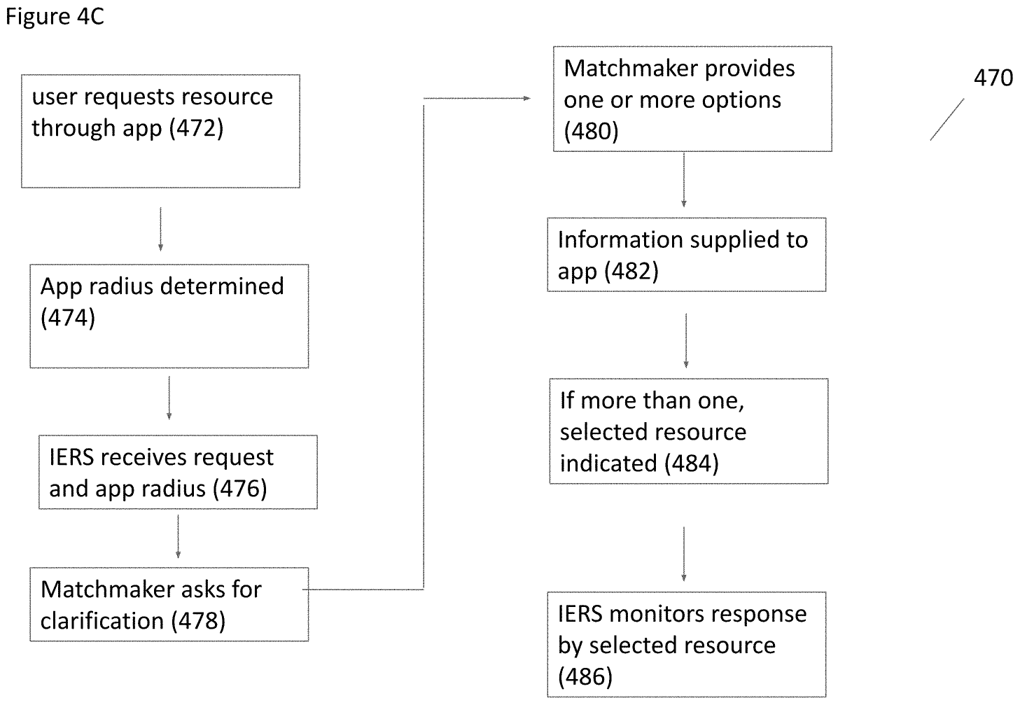

FIG. 4A relates to a non-limiting exemplary flow for analyzing information, in terms of a request for a community resource or information regarding a community event or action, by an artificial intelligence engine as described herein. As shown with regards to a flow 400, text inputs are received in 402, and are then preferably tokenized in 404, for example, according to the techniques described previously. Next, the inputs are fed to AI engine 406, and the inputs are processed by the AI engine in 408. The information received is compared to the desired information in 410. The desired information preferably includes markers for details that should be included.

In the non-limiting example of crimes for example, the details that should be included preferably relate to such factors as the location of the alleged crime, preferably with regard to a specific address, but at least with enough identifying information to be able to identify where the crime took place, details of the crime such as who committed it, or who is viewed as committing it, if in fact the crime was viewed, and also the aftermath. Was there a broken window? Did it appear that objects had been stolen? Was a car previously present and then perhaps the hubcaps were removed? Preferably the desired information includes any information which makes it clear which crime was committed, when it was committed and where.

In the non-limiting example of a health situation, the details preferably relate to symptoms and who has them—for example, the user themselves, a family member, a friend, or a neighbor. The user may be prompted for more details in order to determine whether the health situation is an emergency, for example with regard to whether the sufferer is unconscious, having trouble breathing or other experiencing urgent symptoms. The length of time during which these symptoms have occurred is preferably prompted, if not entered by the user.

In 412 then the information details are analyzed and the level of these details is determinant in 414. Any identified bias is preferably removed in 416. For example with regard to crime tips, this may relate to sensationalized information such as, it was a massive fight, or information that is more emotional than relating to any specific details, such as for example the phrase “a frightening crime”. Other non-limiting examples include the race of the alleged perpetrator as this may this introduce bias into the system. Bias may relate to specific details within a particular report or may relate to a history of a user providing such reports.

In terms of details within a particular report, optionally bias is preset or predetermined during training the AI engine as described in greater detail below. Examples of bias may relate to the use of “sensational” or highly emotional words, as well as markers of a prejudice or bias by the user. Bias may also relate to any overall trends within the report, such as a preponderance of highly emotional or subjective description.

Next, the remaining details are matched to the request in 418 and the output quality is determined in 420. This process is preferably repeated for a plurality of reports received from a plurality of different users, also described as sources herein. The relative quality of such reports may be determined, to rank the reports and also to rank the users.

FIG. 4B illustrates a method 450 for providing community intelligence information based on a user's requests, in accordance with one or more implementations of the present invention, in which the location of the user's phone is determined as part of the community provision. In Step 452, the method 450 begins with a user requesting information through the user app interface 112 operating on the user computational device 102. Next, in Step 454, a token from the unique address is the deducted. The user app interface 112 then determines the app radius (Step 456). The user app interface 132 sends the user's request for crime intelligence information to the server app interface 132 operating on the server gateway 120. The server app interface 132 receives this request (Step 458) and then reads the radius information (Step 460). The server app interface 410 returns the requested information to the user app interface 112 (Step 462). Finally, the user accesses the information using the user app interface 112.

FIG. 4C relates to a non-limiting, exemplary flow for matching the user's request to a particular resource at a particular level, according to the user's request and resource availability. As shown in a flow 470, the user requests a resource through the app at 472. Such a resource may be related to the environment, public safety, health, emergencies, urgent situations, nuisance situations (for example relating to noise or garbage) and the like. The request provided through the app does not need to identify the resource that is required. For example, the request may indicate only that there is a building that is burning, a crime in progress, loud noises in the area, a sick or injured person, and so forth.

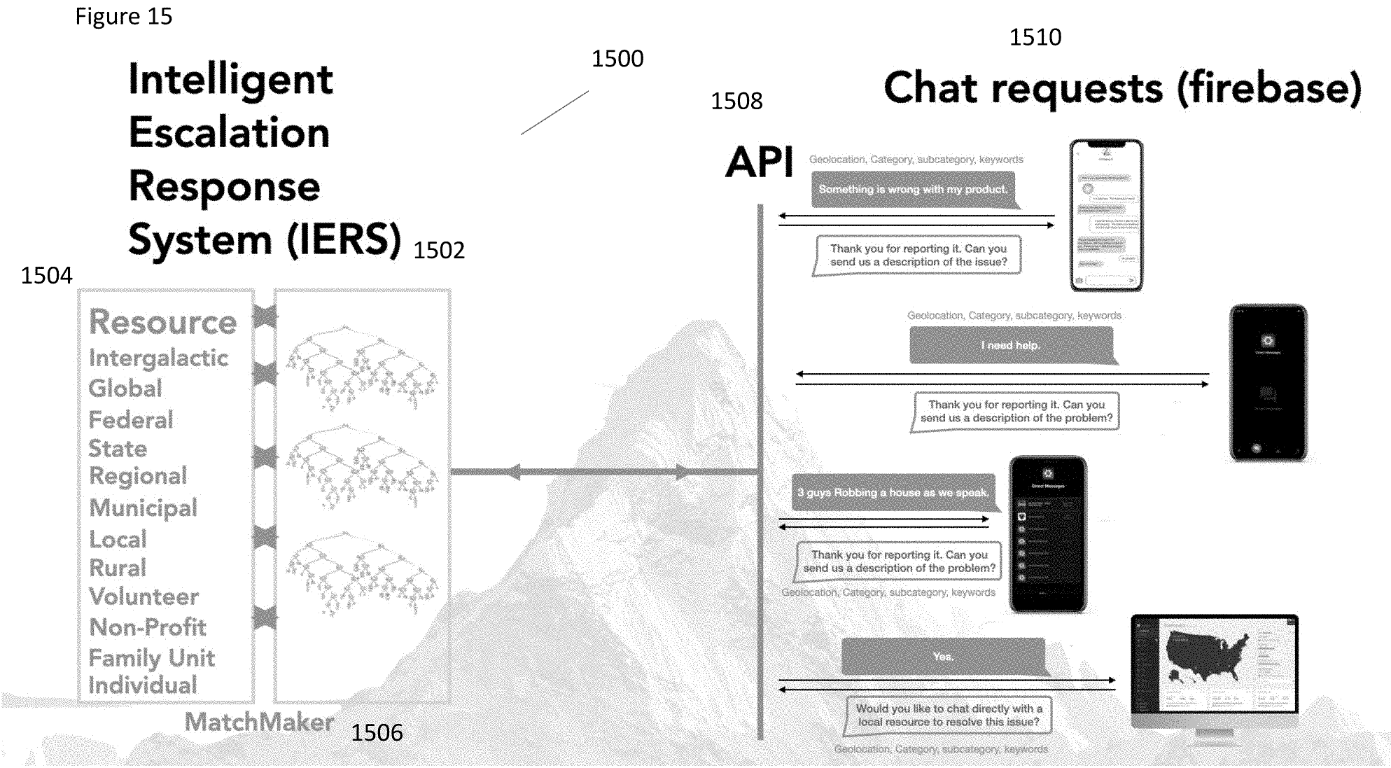

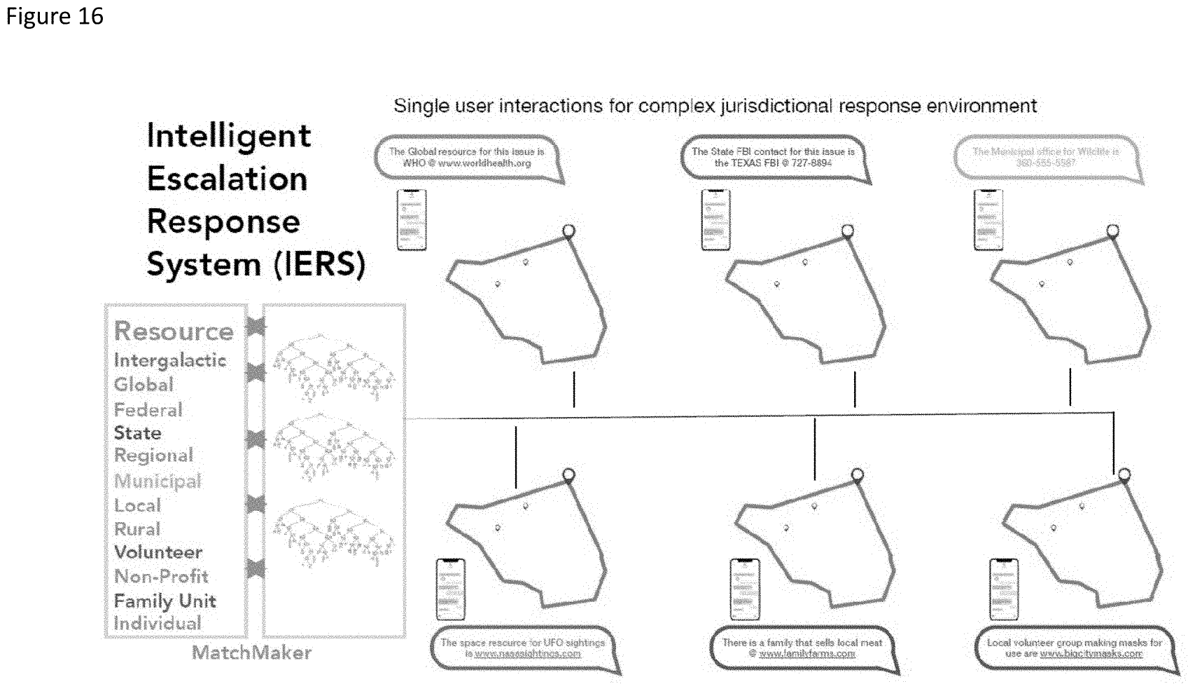

At 474, the app radius and location is determined. The location of the app is important for identifying which resources are appropriate; as resources become more local, then the appropriate radius of the app becomes smaller. For example, the location of the app may be used to determine which country-based, state, regional, municipal and local resources are suitable (see FIGS. 15 and 16 for more detail.

At 476, the Intelligent Escalation Response system (IERS) receives the request and the app radius. The IERS is unique in that it has a dynamic resource base that can be updated to serve the end user with more accuracy than current solutions. Current solutions require the user to either search online for help or to call numbers in a directory to search for help. The IERS automatically receives updates regarding availability of certain resources so that the end user isn't required to reach out multiple times to receive the required help for a single situation. The IERS can then automatically connect users to resources which are up to date and available. Such automatic matching can save time, resources and energy during a crisis or urgent response, and help every citizen or customer feel heard.

Non-limiting examples of such resources as shown are Individual, Family Unit, Non-Profit, Volunteer, Rural, Local, Municipal, Regional, State, Federal, Global and Intergalactic (outer space, non-Earth based resources). Each resource represents an escalation of a situation and of the need for a solution to a higher level, such that Federal represents a larger area than State.

The server receiving the request at the IERS features a matchmaking system, which is preferably implemented with the previously AI engine for natural language processing (NLP). The matchmaking system analyzes the received request and may request clarification at 478. For example the matchmaking system may ask for more information to determine whether the user associated with the app making the request is in a safe place or is in immediate danger, whether others are in immediate danger, whether the user is at the location that requires the resource and so forth.

The matchmaking system then determines which resources are suitable. Suitable resources are preferably determined according to a combination of the app radius or other geofencing, the specific app request and availability of a particular resource. Availability is in turn preferably determined according to a combination of the app radius or other geofencing, once the list of resources that could service the app request is determined. Alternatively, geofencing is used to determine all available resources, followed by selection according to the app request.

The geolocation as a factor enables the resource to provide a clearly defined resource radius that they can service. For an in person service provider that travels to a particular physical location, for example for a repair or to solve an urgent public safety or health situation, such a resource may set the geofence to within ˜25 km of the user report. Such a geofence may be decreased for a dense urban area and increased for less densely populated rural area. This can be updated so the dynamic response of the IERS, as determined by the matchmaking system, is updated accordingly. Preferably information provided by the resources changes dynamically as their resource capabilities change. As they grow or shrink in terms of geolocation size, they can adjust the radius on their portal and the future request matchmaking will reflect those changes.

At 480, the matchmaking system provides one or more options for suitable resources. For example, if the app request indicates that a building is on fire, then the matchmaking system may suggest the fire department, the police department or emergency rescue services as being appropriate. This information is supplied to the app at 482, after which the user may select one or more resources through the app at 484. For example, the user may indicate that both police and firefighters are required, if the fire is somehow suspicious.

The IERS then monitors the response by the selected resource at 486. Such a response may be immediate or may be more long term. The IERS is able to contact the selected resources through the previously provided integrated channel if available. If not, then the IERS may instead only contact the user through the app to determine whether the selected resource responded appropriately.

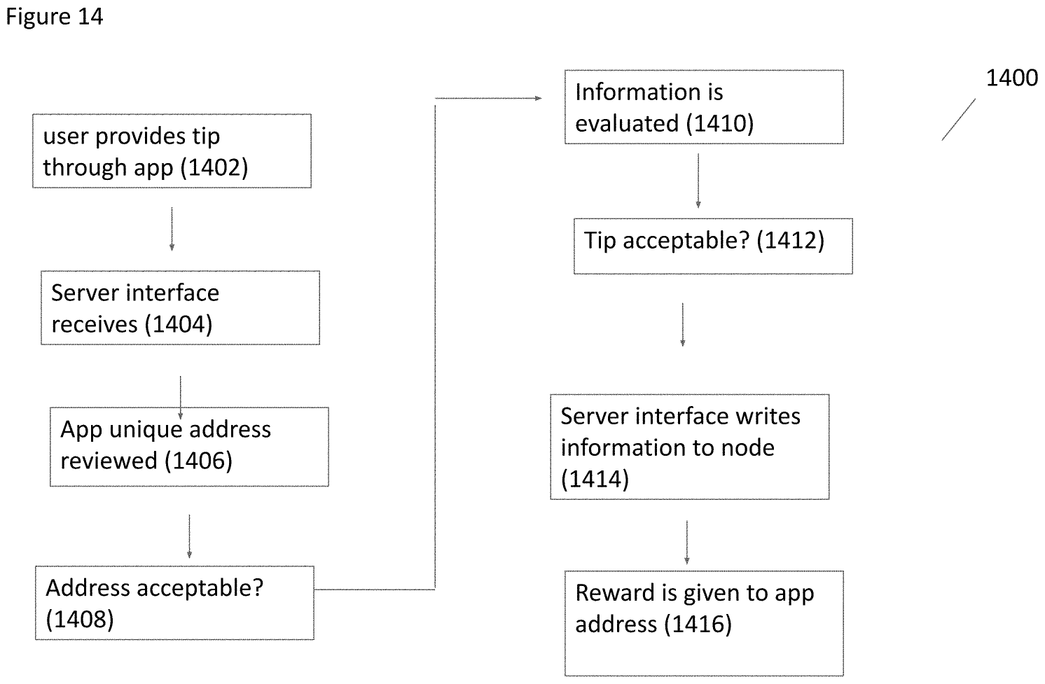

Such a response may also relate to whether the user and/or the resource receives a reward, for example as determined according to FIG. 14. Optionally, every user and every resource in the network operates with a crypto wallet address whether they are “known” and also whether they have chosen to integrate or connect to the IERS. This allows publishers of information to earn such a reward, for resources to earn based on response (which helps with reputation scores, ratings, and incentivizes participation) and for the user to earn based upon appropriate requests which are not time-wasting or resource-wasting.

Validation may be conducted using a similar method as for FIG. 14 or as otherwise described herein, to only pay out validated reports, and hold value in escrow until issues are confirmed as resolved. This incentivizes both sides of the network to interact with each other. This is also the accountability measurement to analyze the “value” the resource brings to the network response. This accountability measurement can also look for inefficient response resources and poor performance.

This verification method becomes a novel way of generating monitoring the data necessary for government, businesses, and community led responses to issues. People can provide the best intelligence but it can be difficult to develop a relationship—this does not require authority to have a relationship with the person. Digital twin.

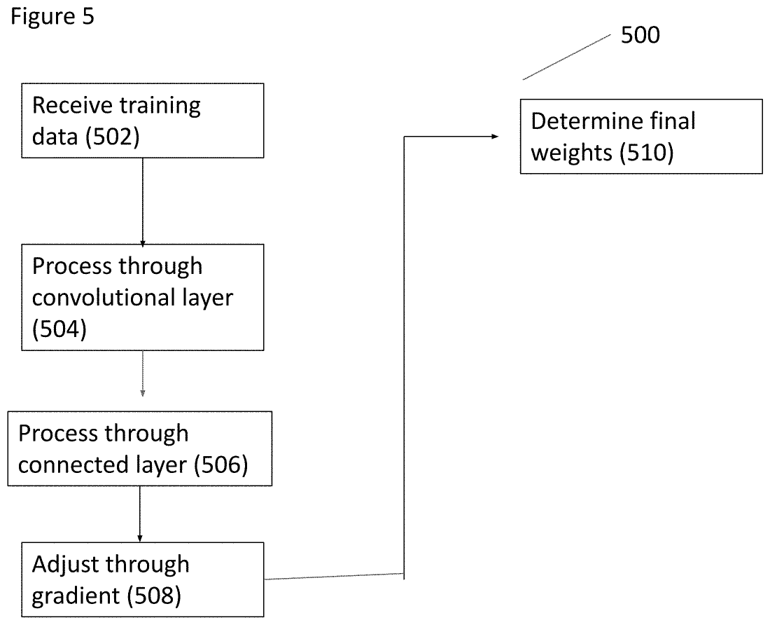

FIG. 5 relates to a non-limiting exemplary flow for training the AI engine. As shown with regard to flow 500, the training data is received in 502 and it is processed through the convolutional layer of the network in 504. This is if a convolutional neural net is used, which is the assumption for this non-limiting example. After that the data is processed through the connected layer in 506 and adjust according to a gradient in 508. Typically, a steep descent gradient is used in which the error is minimized by looking for a gradient. One advantage of this is it helps to avoid local minima where the AI engine may be trained to a certain point but may be in a minimum which is local but it's not the true minimum for that particular engine. The final weights are then determined in 510 after which the model is ready to use.

In terms of provision of the training data, as described in greater detail below, preferably the training data is analyzed to clearly flag examples of bias, in order for the AI engine to be aware of what constitutes bias. During training, optionally the outcomes are analyzed to ensure that bias is properly flagged by the AI engine.

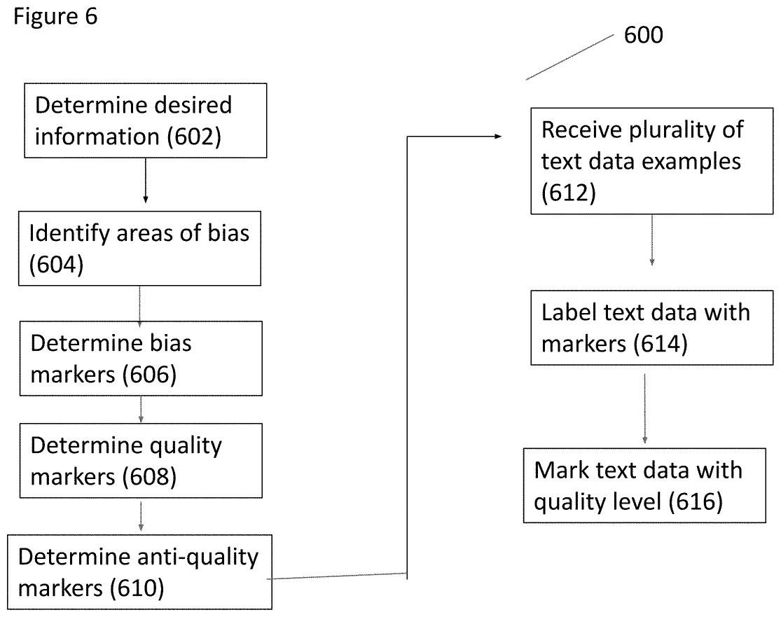

FIG. 6 relates to a non-limiting exemplary method for obtaining training data. As shown with regard to a flow 600, the desired information is determined in 602. For example, for crime tips, again, it's where the alleged crime took place, what the crime was, details of what happened, details about the perpetrator if in fact this person was viewed.

Next in 604, areas of bias are identified. This is important in terms of adjectives which may sensationalize the crimes such as a massive fight as previously described, but also of areas of bias which may relate to race. This is important for the training data because one does not want the AI model to be training on such factors as race but only on factors such as the specific details of the crime and/or specific details of the resource request and/or of the health or other community situation.

Next, bias markers are determined in 606. These bias markers are markers which should be flagged and either removed or in some cases actually cause the entire information to be removed. These may include race, these include sensationalist adjectives, and other information which does not further relate to the concreteness of the details being considered.

Next, quality markers are determined in 608. These may include a checklist of information. For example if the crime is burglary, one quality marker might be if any peripheral information is included such as for example whether a broken window is viewed at the property, if the crime took place in a particular property, what was stolen if that is no, other information such as whether or not a burglar alarm went off, the time at which the alleged crime took place, if the person is reporting it after the fact and didn't see the crime taking place, when did they report it, and when did they think the crime took place, and so forth.

Next, the anti-quality markers are determined in 610. These are markers which detract from report. Sensationalist information for example can be stripped out, but it may also be used to detract from the quality of the report as would the race of the person if this is shown to include bias within the report. Other anti-quality markers could for example include details which could prejudice either an engine or a person viewing the information or the report towards a particular conclusion such as, “I believe so and so did this.” This could also be a quality marker, but it can also be an anti-quality marker, and how such information is handled depends also on how the people who are training the AI view the importance of this information.

Next, the plurality of text data examples are received in 612, and then this text data is labeled with markers in 614, assuming it does not come already labeled. Then the text data is marked with the quality level in 616.

In terms of training for FIGS. 5 and 6, intents may also be used. For example, when the user requests help through the app (which is in effect a resource request), such requests for help may be manually labeled to indicate the appropriate resource. To avoid manually labeling all data, semi-supervised methods may be used to label the data. In these methods, manually labeled data is extended according to categories or classifications. Intents may be useful for such methods, as it is possible to group large amounts of user requests into an intent for a particular type of resource. Intents may also be used to determine the intention of the user. Intents may be used to distinguish between an information request and the submission of novel, unique, and useful information that isn't previously known to the system, in regard to the intention of the user.

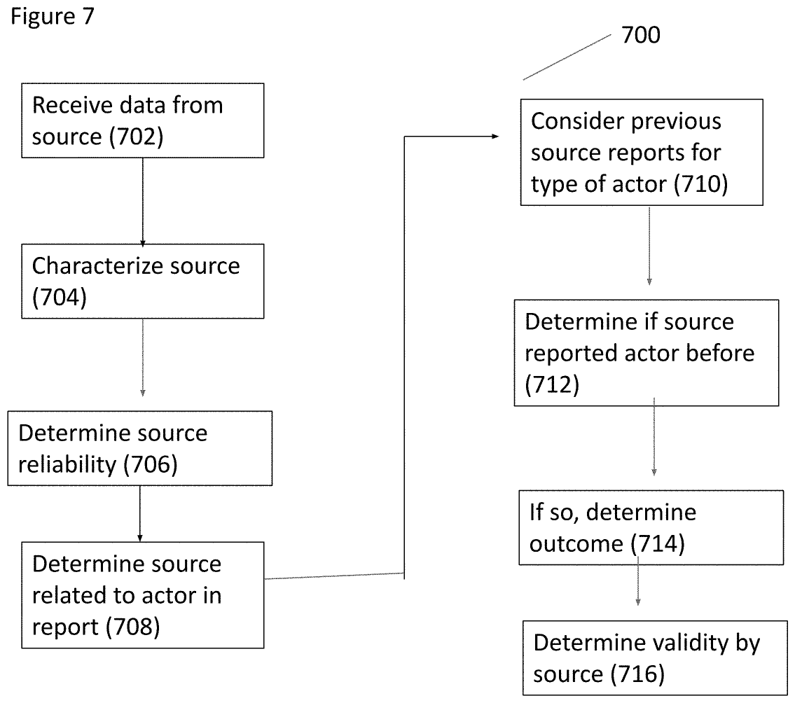

FIG. 7 relates to a non-limiting exemplary method for evaluating a source for data. As shown in the flow 700, data is received from a source 702, which for example could be a particular user identified as previously described. The source is then characterized in 704. Characterization could include such information as the previous reliability of reports of the source, previous information given by the source, whether or not this is the first report, whether or not the report source has shown familiarity with the subject matter. For example, if a source is reporting a crime in a particular neighborhood, some questions that may be considered are whether the source reported that they previously or currently live in the neighborhood, regularly visit the neighborhood, were in the neighborhood for a meeting or running. For a community health situation, information regarding whether the user is sick or a family member is sick, particularly with regard to specific symptoms and the duration of such symptoms, is helpful. Any such information may help characterize how and why the source might have come across this information, and therefore why they should be trusted.

In other cases such as for example a matter which relates to subject matter expertise, for example for a particular type of request for biological information, what could be considered here would be the source's expertise. For example, if the source is a person, questions of expertise would relate to whether the source has an educational background in this area, are currently working in a lab, or previously worked in a laboratory in this area and so forth.

Next, the source's reliability is determined in 706 from the characterization factors but also from previous reports given by the source, for example according to the below described reputation level for the source. For example, for a source who is connected to a particular app, follow through on resource access and appropriate consumption may be considered in relation to reliability. As noted with regard to FIG. 4C, the source (requesting user) may be rewarded for follow-through with a requested resource and appropriate resource consumption. Such metrics may also be used to determine source reliability.

Next is determined whether the source is related to an actor in the report in 708. In the case of crime, this is particularly important. On the one hand, in some cases, if the source knows the actor, this could be advantageous. For example, if a source is reporting a burglary and they know the person who did it, and they saw the person with the stolen merchandise, this is clearly a factor in favor of the source's reliability. On the other hand, in other cases it might also be indication of a grudge, if the source is trying to implicate a particular person in a crime, this may be an indication that the source has a grudge against the person and therefore reduce their reliability. Whether the source is related to the actor is important, but may not be dispositive as for the reliability of the report.

Relationships between sources and resources may also be important to determine. If a source consistently requests access to a particular resource, determining the relationship between the source and the resource may be useful. If the source requests access to a certain resource but then does not follow through, this may be a characteristic of the source but may also indicate a problematic relationship with the resource—for example, known healthcare and police biases against ethnic minorities in certain countries or areas.

Next, in 710 the process considers previous source reports for this type of actor. This may be important in cases where a source repeatedly identifies actors by race, there may therefore be bias in this case, indicating that the person has a bias against a particular race. Another issue is also whether the source has reported this particular type of actor before in the sense of bias against juveniles, or bias against people who tend to hang out at a particular park or other location.

Next, in 712 it is determined whether the source has reported the actor before.

Again, as in 708, this is a double-edge sword. If it indicates familiarity with the actor, it may be a good thing or it may indicate that the source has a grudge against the actor.

In 714, the outcome is determined according to all of these factors such as the relationship between the source and the actor, whether or not the source has given previous reports for this type of actor or for this specific actor. Then the validity is determined by source in 716 which may also include such factors as source characterization and source reliability.

The above process is preferably repeated for a plurality of sources. The greater the number of sources contributing reports and information, the more accurate the process becomes, in terms of determining the overall validity of the provided report.

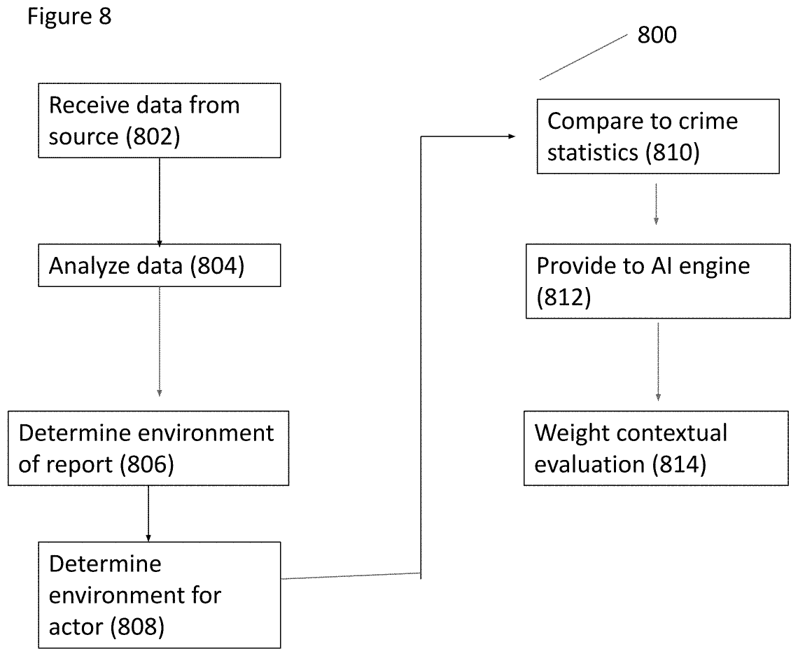

FIG. 8 relates to a non-limiting exemplary method for performing context evaluation for data. As shown in the flow 800, data is received from a source, 802, and is analyzed in 804. Next, the environment of the report is determined in 806. For example, for a crime, this could relate to the type of crime reported in a particular area. If a pickpocket event is reported in an area which is known to be frequented by pickpockets and have a lot of pick pocketing crime, this would tend to increase the validity of the report. On the other hand, if a report of a crime indicates that a TV was stolen from a store but there are no stores selling TVs in that particular area, then that would reduce the validity of the report given that the environment does not have any stores that would sell the object that was apparently stolen.

In 808 the environment for the actor is determined. Again, this relates to whether or not the actor is likely to have been in a particular area at a particular time. If a particular actor is named and that actor lives on a different continent and was not actually visiting the continent or country in question at the time, this would clearly reduce the validity of the report. Also, if one is discussing a crime by a juvenile and this is during school hours, it would also then actually determine whether or not the juvenile actually had attended school. If the juvenile had been in school all day, then this would again count against the environmental analysis.

In 810 the information is compared to crime statistics, again, to determine likelihood of crime, and all this information is provided to the AI engine in 812. In 814 the contextual evaluation is then weighted. These are all the different contexts for the data and the AI engine determines whether or not based on these contexts the event was more or less likely to have occurred as reported and also the relevance and reliability of the report.

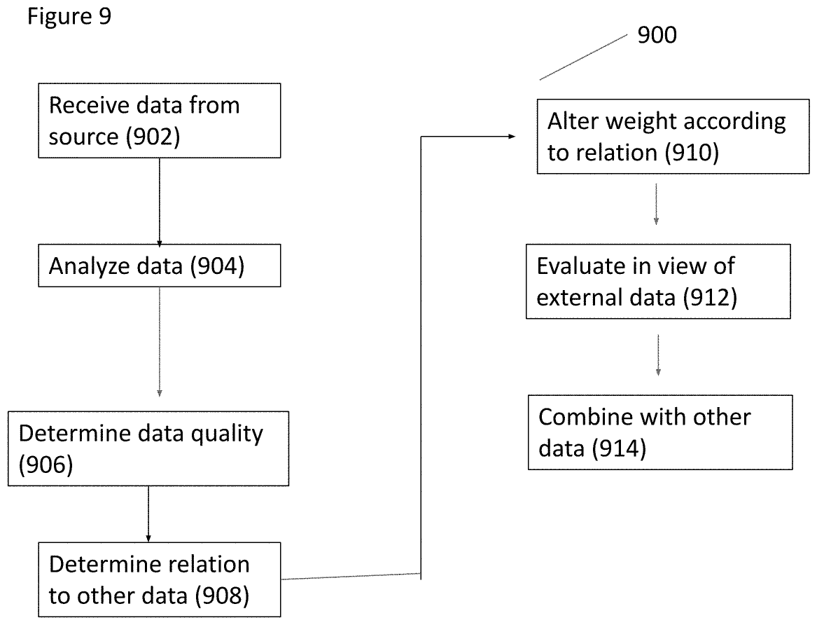

FIG. 9 relates to a non-limiting exemplary method for connection evaluation for data. The connections that are evaluated preferably relate to connections or relationships between various sets or types of data, or data components. As shown in the flow 900, data is received from the source 902 and analyzed in 904. Optionally such analysis includes decomposing the data into a plurality of components, and/or characterizing the data according to one or more quality markers. A non-limiting example of a component is for example a graph, a number or set of numbers, or a specific fact. With regard to the example of a crime tip or report, the specific fact may relate to a location of a crime, a time of occurrence of the crime, the nature of the crime and so forth. With regard to the request for another type of resource, it is possible to decompose the data into intents or other characterizations which are more easily analyzed or quantified.

The data quality is then determined in 906, for example according to one or more quality markers determined in 904. Optionally data quality is determined per component. Next, the relationship between this data and other data is determined in 908. For example, the relationship could be multiple reports for the same crime, fire, flood, or other acute public safety situation. If there are multiple reports for the same crime, fire, flood, or other acute public safety situation, the importance would be then connecting these reports and showing whether or not the data in the new report substantiates the data in previous report, contradicts the data in previous reports, and also whether or not multiple reports solidify each other's data or contradict each other's data. Triangulation of the various locations of the relevant apps making the report may also be useful for determining the relative weight of different reports for determining data quality.

This is important because if there are multiple conflicting reports, if it is not clear what acute public safety situation exactly occurred, or details of the acute public safety situation such when and how or what happened, or if something was stolen or damaged, what was stolen or damaged, then this would indicate that the multiple reports are less reliable because reports should preferably reinforce each other.

The relationship may also be determined for each component of the data separately, or for a plurality of such components in combination.

In 910 the weight is altered according to the relationship between the received data and previously known data, and then all of the data is preferably combined in 912. Optionally data from a plurality of different sources and/or reports may be combined. One non-limiting example of a method for combining such data is related to risk terrain mapping. In the context of data related to crime tips, such risk terrain mapping may relate to combining data and/or reports to find “hot spots” on a map. Such a map may then be analyzed in terms of the geography and/or terrain of the area (city, neighborhood, area, etc.) to theorize why that particular category of crime report occurs more frequently than others. For example, effects of terrain in a city crime context may relate to housing types and occupancy, business types, traffic, weather, lighting, environmental design, and the like, which could affect the patterns of crime occurring in that area. Such an analysis may assist in preventing or reducing crimes in a particular category.

In terms of non-crime data, the risk terrain mapping or modeling may involve actual geography, for example for acute or chronic diseases, or for any other type of geographically distributed data or effects. However such mapping may also occur across a virtual geography for other types of data.

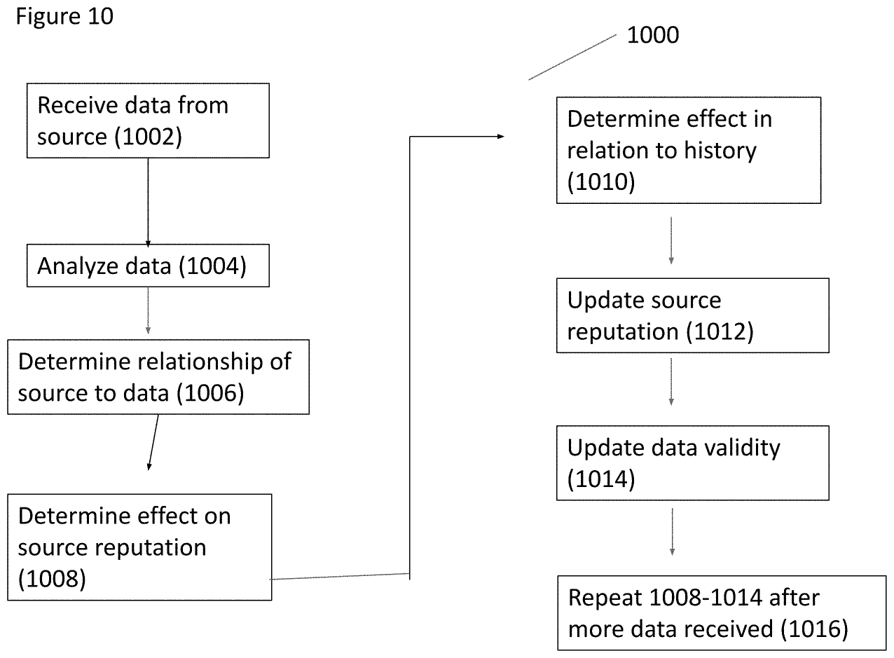

FIG. 10 relates to a non-limiting exemplary method for source reliability evaluation. In this context, the term “source” may for example relate to a user as described herein (such as the user of FIG. 1) or to a plurality of users, including without limitation an organization. A method 1000 begins by receiving data from a source 1002. The data is identified as being received from the source, which is preferably identifiable at least with a pseudonym, such that it is possible to track data received from the source according to a history of receipt of such data.

Such an approach with a pseudonym is supported by a blockchain wallet as described herein. The blockchain wallet may be identified through a pseudonym which is trackable through multiple transactions, while still preserving the privacy of the user associated with the wallet (for example, by keeping the name and other contact details of the user private). Without wishing to be limited by a closed list, among these advantages is the ability to build reputation and to also offer the potential of the user to be connected through a particular organization or network. In relation to the first aspect, users are able to build their reputation through a series of actions. They are also able to add reputation to their blockchain (wallet) identifier. They are also able to see the additional “risk” score by adding attributes to their wallet. In relation to the second aspect, this approach increases the authentication of users by linking them to their original network connected to a particular organization, government body, company and so forth, while again maintaining the privacy of their personal details.

Next the data is analyzed in 1004. Such analysis may include but is not limited to decomposing the data into a plurality of components, determining data quality, analyzing the content of the data, analyzing metadata and a combination thereof. Other types of analysis as described herein may be performed, additionally or alternatively.

In 1006, a relationship between the source and the data is determined. For example, the source may be providing the data as an eyewitness account. Such a direct account is preferably given greater weight than a hearsay account. Another type of relationship may involve the potential for a motive involving personal gain, or gain of a related third party, through providing the data. In case of a reward or payment being offered for providing the data, the act of providing the data itself would not necessarily be considered to indicate a desire for personal gain. For scientific data, the relationship may for example be that of a scientist performing an experiment and reporting the results as data. The relationship may increase the weight of the data, for example in terms of determining data quality, or may decrease the weight of the data, for example if the relationship is determined to include a motive related to personal gain or gain of a third party.

In 1008, the effect of the data on the reputation of the source is determined, preferably from a combination of the data analysis and the determined relationship. For example, high quality data and/or data provided by a source that has been determined to have a relationship that involves personal gain and/or gain for a third party may increase the reputation of the source. Low quality data and/or data provided by a source that has been determined to have a relationship involving such gain may decrease the reputation of the source. Optionally the reputation of the source is determined according to a reputation score, which may comprise a single number or a plurality of numbers. Optionally, the reputation score and/or other characteristics are used to place the source into one of a plurality of buckets, indicating the trustworthiness of the source—and hence also of data provided by that source.

The effect of the data on the reputation of the source is also preferably determined with regard to a history of data provided by the source in 1010. History of data may be substituted for or augmented by appropriate resource requests, follow-through and consumption. Optionally the two effects are combined, such that the reputation of the source is updated for each receipt of data or resource request from the source. Also optionally, time is considered as a factor. For example, as the history of receipts of data and/or resource requests from the source evolves over a longer period of time, the reputation of the source may be increased also according to the length of time for such history. For example, for two sources which have both made the same number of data provisions or resource requests, a greater weight may be given to the source for which such data provisions or resource requests were made over a longer period of time.

In 1012, the reputation of the source is updated, preferably according to the calculations in both 1008 and 1010, which may be combined according to a weighting scheme and also according to the above described length of elapsed time for the history of data provisions and/or resource requests.

In 1014, the validity of the data is optionally updated according to the updated source reputation determination. For example, data from a source with a higher determined reputation is optionally given a higher weight as having greater validity.

Optionally, 1008-1014 are repeated at least once, after more data is received, in 1016. The process may be repeated continuously as more data is received. Optionally the process is performed periodically, according to time, rather than according to receipt of data. Optionally a combination of elapsed time between performing the process and data receipt is used to trigger the process.

Optionally reputation is a factor in determining the speed of remuneration of the source, for example. A source with a higher reputation rating may receive remuneration more quickly. Different reputation levels may be used, with a source progressing through each level as the source provides consistently valid and/or high quality data over time. Time may be a component for determining a reputation level, in that the source may be required to provide multiple data inputs over a period of time to receive a higher reputation level. Different reputation levels may provide different rewards, such as higher and/or faster remuneration for example.

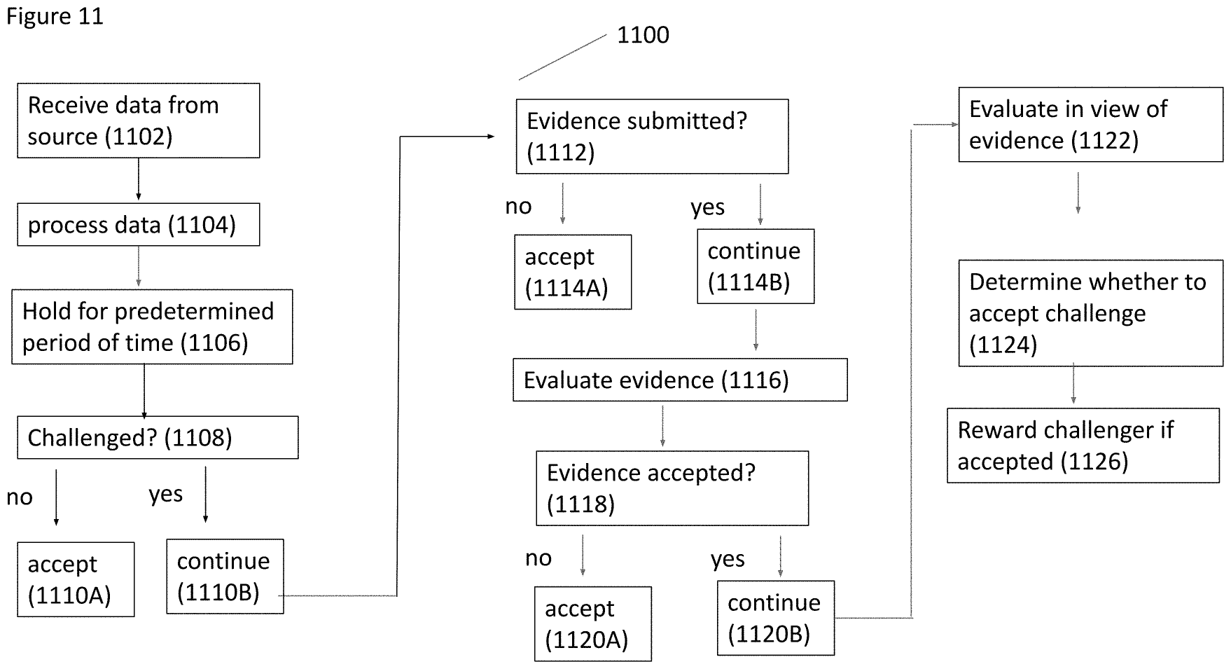

FIG. 11 relates to a non-limiting exemplary method for a data challenge process. The data challenge process may be used to challenge the validity of data that is provided, in whole or in part. A process 1100 begins with receiving data from a source in 1102, for example as previously described. In 1104, the data is processed, for example to analyze it and/or associated metadata, for example as described herein. A hold is then placed on further processing, analysis and/or use of the data in 1106, to allow time for the data to be challenged. For example, the data may be made available to one or more trusted users and/or sources, and/or to external third parties, for review. A reviewer may then challenge the validity of the data during this holding period.

If the validity of the data is not challenged in 1108, then the data is accepted in 1110A, for example for further analysis, processing and/or use. The speed with which the data is accepted, even if not challenged, may vary according to a reputation level of the source. For example, for sources with a lower reputation level, a longer period of time may elapse before the data is accepted. For sources with a lower reputation level, there may be a longer period of time during which challenges may be made. By contrary, for sources with a higher reputation level, such a period of time for challenges may be shorter. As a non-limiting example, for sources with a lower reputation level, the period of time for challenges may be up to 12 hours, up to 24 hours, up to 48 hours, up to 168 hours, up to two weeks or any time period in between. For sources with a higher reputation level, such a period of time may be shortened, by 25%, 50%, 75% or any other percentage amount in between.

If the validity of the data is challenged in 1108, then a challenge process is initiated in 1110B. The challenger is invited to provide evidence to support the challenge in 1112. If the challenger does not submit evidence, then the data is accepted as previously described in 1114A. If evidence is submitted, then the challenge process continues in 1114B.

The evidence is preferably evaluated in 1116, for example for quality of the evidence, the reputation of the evidence provider, the relationship between the evidence provider and the evidence, and so forth. Optionally and preferably the same or similar tools and processes are used to evaluate the evidence as described herein for evaluating the data and/or the reputation of the data provider. The evaluation information is then preferably passed to an acceptance process in 1118, to determine whether the evidence is acceptable. If the evidence is not acceptable, then the data is accepted as previously described in 1120A.

If the evidence is acceptable, then the challenge process continues in 11206. The challenged data is evaluated in light of the evidence in 1122. If only one or a plurality of data components were challenged, then preferably only these components are evaluated in light of the provided evidence. Optionally and preferably, the reputation of the data provider and/or of the evidence provider are included in the evaluation process.

In 1124, it is determined whether to accept the challenge, in whole or in part. If the challenge is accepted, in whole or optionally in part, the challenger is preferably rewarded in 1126. The data may be accepted, in whole or in part, according to the outcome of the challenge. If accepted, then its weighting or other validity score may be adjusted according to the outcome of the challenge. Optionally and preferably, the reputation of the challenger and/or of the data provider is adjusted according to the outcome of the challenge.

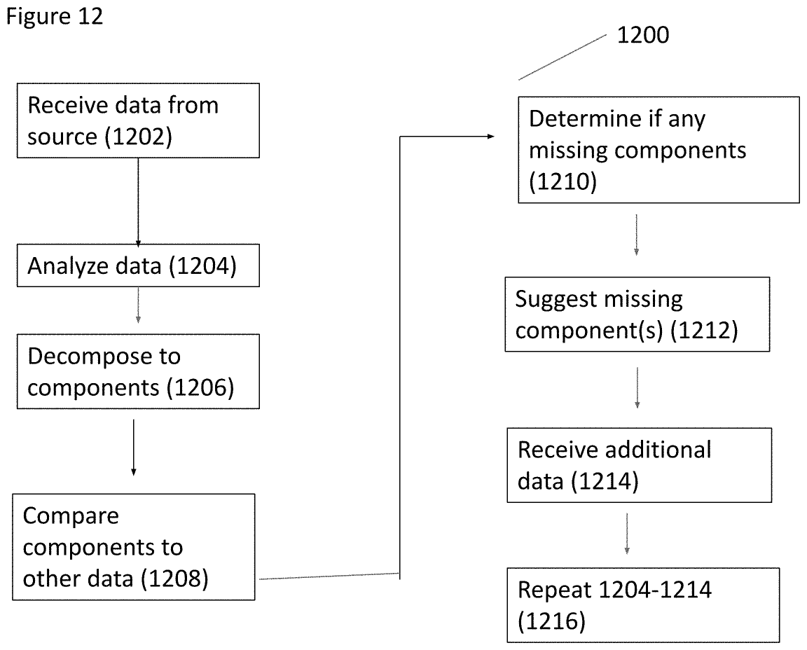

FIG. 12 relates to a non-limiting exemplary method for a reporting assistance process. This process may be performed for example through the previously described user app, such that when a user (or optionally a source of any type) reports data, assistance is provided to help the user provide more complete or accurate data. A process 1200 begins with receiving data from a source, such as a user, in 1202. The data may be provided through the previously described user app or through another interface. The subsequent steps described herein may be performed synchronously or asynchronously. The data is then analyzed in 1204, again optionally as previously described. In 1206, the data is preferably broken down into a plurality of components, for example through natural language processing as previously described.

The data components are then preferably compared to other data in 1208. For example, the components may be compared to parameters for data that has been requested. For the non-limiting example of a crime tip or report, such parameters may relate to a location of the crime, time and date that the crime occurred, nature of the crime, which individual(s) were involved and so forth. Preferably such a comparison is performed through natural language processing.

As a result of the comparison, it is determined whether any data components are missing in 1210. Again for the non-limiting example of a crime tip or report, if the data components do not include the location of the crime, then the location of the crime is determined to be a missing data component. For each missing component, optionally and preferably a suggestion is made as to the nature of the missing component in 1212. Such a suggestion may include a prompt to the user making the report, for example through the previously described user app. As a result of the prompts, additional data is received in 1214. The process of 1204-1214 may then be repeated more than once in 1216, for example until the user indicates that all missing data has been provided and/or that the user does not have all answers for the missing data.

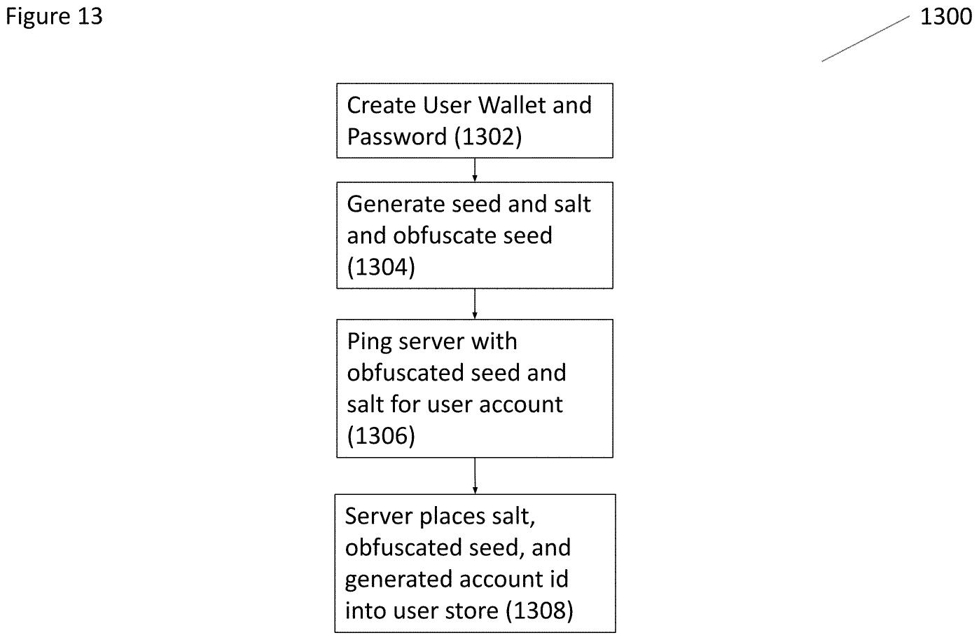

FIG. 13 illustrates a method of securing the user wallet 116 through a verifiable means of connecting wallet seeds in an obfuscated way with a particular known user identity. The user identity may be verified through a digital identity of some type and/or may be verified by supplying the scan of a user identity card or other information.

In a method 1300, user creates a user wallet 116 on the user computational device 102 and provides a password to the user wallet 116 (Step 1302). The user wallet 116 generates a seed and salt and obfuscates the seed using encryption (Step 1304). The user wallet 116 then pings a server 120 with the obfuscated seed and salt for the user account, where the user account is located on the user computational device 102 (Step 1306). The obfuscated seed is also encrypted on the server 120. The server 120 places the salt, the obfuscated seed, and a generated account id (pseudo-random hash) into the user store, where the generated account id is used to track data coming from the user computational device 102 (Step 1308).

FIG. 14 illustrates a method 1400 for receiving community resource request and/or information submitted by users, in accordance with one or more implementations of the present invention. In Step 1402, the method 1400 begins with a user providing a tip through the user app interface 112 operating on the user computational device 102. The user app interface 112 then sends the crime tip to the server app interface 132 operating on the server gateway 120 at step 1404. The server app interface 132 receives the crime tip and then reviews the unique address (Step 1406). If the server app interface 132 determines that the unique address is acceptable (Step 1408), the AI engine 134 evaluates the crime tip using its evaluation criteria (e.g., time, uniqueness, level of verification, and context; step 1410). If the tip is acceptable (Step 1412), the server app interface 132 writes the information to the blockchain node 150A. Finally, the reward (i.e., token) is given to the unique address (Step 1416).

FIG. 15 shows a non-limiting, exemplary system for intelligent escalation response (IERS), which may be implemented for example as described with regard to the functions of FIG. 4C.

As shown in a system 1500, an IERS 1502 features a plurality of resources 1504 at different levels and a matchmaking function 1506. Matchmaking function 1506 matches incoming requests 1510 through an API 1508. Some non-limiting examples of such requests 1510 are shown; matchmaking function 1506 then determines which type of resource is the best fit and transmits information accordingly as shown. IERS 1502 provides event handling functions so that incoming requests are sent to matchmaking function 1506 and then a response may be returned. The requests are preferably provided to IERS 1502 through a websocket, which connects the previously described app (not shown) to IERS 1502. The websocket provides an API for connection to different services or microservice within IERS 1502. Upon receipt of a request, an event is triggered according to a trigger, which is then associated with a key. The response is then sent back through the websocket.

Preferably the resources 1504 are organized into a decentralized resource network, which allows resources to join and leave the network by choice. The network will still generate demand from users to connect with resources until they type a command in the chat like “/escalate” so the issue will be reported to the next level of resources within the network. Such resources may formally register and manage their own account, or they can simply exist as a listing with publicly available information (eg. contact, email, website, etc.) integrated into the system internally.

Preferably only resources that actively join, provide information and actively participate in the IERS receive control over their profile, the extent to which referrals may be made to that resource and also optionally rewards for participating.

For example, the IERS may be implemented as a chatbot, providing responses as short messages, in which the content of the short messages are determined by user request inputs, such that communication between the user app and the IERS is in the form of “chat”. An integrated resource could choose to connect its computer system to the IERS through an SDK, to provide a customized response from that computer system. Alternatively or additionally, the resource could provide answers to the IERS chatbot or could substitute the IERS chatbot with its own chatbot, whether through the app or another text messaging channel, or their website.

FIG. 16 shows non-limiting examples of different situations and the levels of resources to which these situations may be matched, according to the content of the situation itself and the report made by the end user. A series of single user-interactions with the IERS is represented, along with a potential match to a resource that may be sent to the user as a message through the previously described app. For example, the user may be told (left upper row, orange) that the Global resource for this issue is WHO @ www.worldhealth.org. In the middle of the upper row, dark green, the user is told that the State FBI contact for this issue is the TEXAS FBI @ 727-8894. Right upper row, yellow, indicates a message in which the user is told that the Municipal office for Wildlife is 360-555-5587.

At left lower row, bright green, the user is told that the space resource for UFO sightings is www.nasasightings.com. At the middle lower row, blue, the user is told that there is a family that sells local meat @ www.familyfarms.com. At the right lower row, dark pink the user is told that there is a local volunteer group making masks for use @ www.bigcitymasks.com.

Each such message represents a single user interaction for complex jurisdictional response environment, in which the end user does not need to determine the correct jurisdictional level at which a resource should be sought, nor does the end user need to determine the correct resource or organization to contact. This architecture allows for dynamic integration of resources at any level to be integrated to the escalation response system. The criteria can be customized as well as the response. If the Resources have declining or increasing unit value available (in terms of what they provide as a product or service), they can update the entire system so that the end user is re-routed to the next available service. This operates similar to an ad network where the best options can be presented first and the lower quality services can be presented if there is no other alternative. This allows for an increase in satisfaction of the user experience.

The definition of unit value relates to the product or service being provided by the resource. Every integrated resource in the system preferably defines the “unit of value” they provide to end users (eg. police response, firefighting response, N95 masks, food, counselling) in order to measure their capacity. For example one resource could indicate that they have 1000 masks available weekly, while a medical clinic could indicate that they can see 50 patients per day. In the first case, the unit is a mask, while in the second case, the unit is a patient visit. This accounting method along with their scheduler enables the availability of the resource to the user in the appropriate geofence or radius to be determined. This specific accounting mechanism can be updated over time by the resource to connect until capacity is reached where the next resource available will be contacted, or the issue will be escalated to higher level for response.

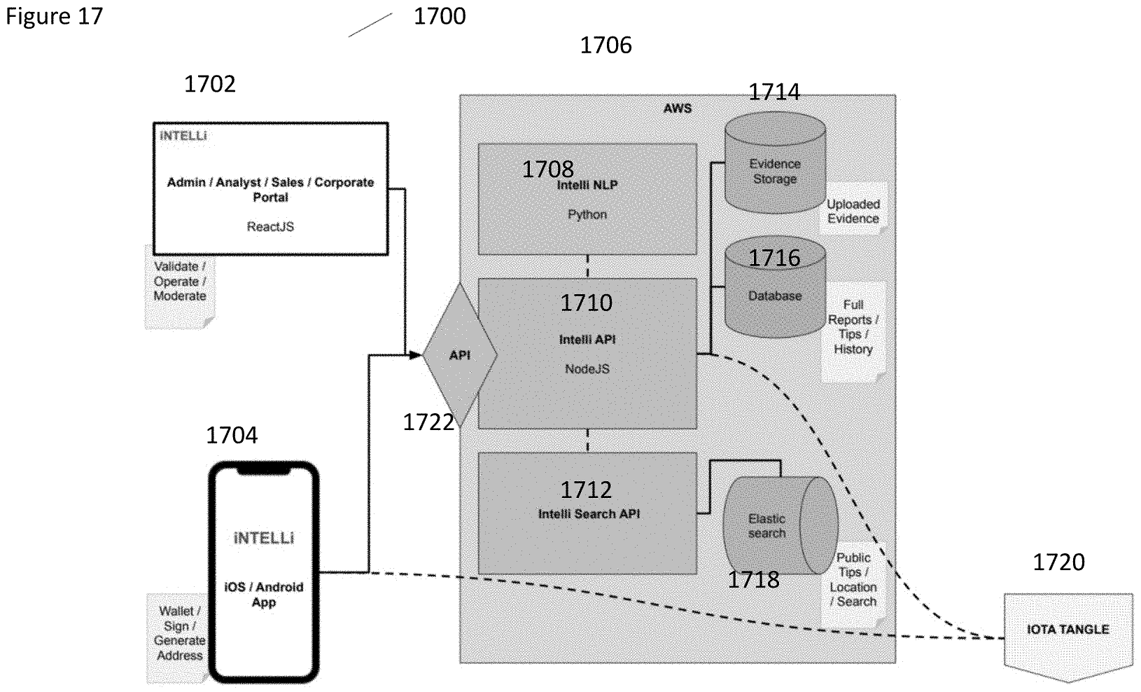

FIG. 17 shows a non-limiting example of another system for intelligent escalation. As shown, a system 1700 features a corporate portal 1702 and an app 1704, connected to a server 1706. App 1704 may be configured as previously described. Corporate portal 1702 permits companies and/or government authorities to view data, receive reports and interact with server 1706. Corporate portal 1702 also permits new resources to be added and/or existing resources to be updated at server 1706.

Server 1706 preferably features an NLP (natural language processing) engine 1708, which is able to understand human text or speech to text. NLP engine 1708 analyzes the received requests from app 1704, combines information as previously described, determines the validity and/or relevancy and also is able to generate reports.

A blockchain API 1710 connects server 1706 to a blockchain 1720, which may for example be configured with an Iota Tangle (a distributed ledger directed acyclic graph configuration). A search engine 1712 preferably features an elastic search 1718 or other search support, so that for example the correct resource is located and connected, for example through direct contact or else by providing information to app 1704. Search engine 1712 preferably also supports third party search for reports or other details about an aggregate amount of user reports or requests.

Evidence is preferably stored in an evidence storage 1714 and is then preferably accessed by NLP engine 1708 and/or by blockchain API 1710. Reports and other information from users, submitted through app 1704 or else generated from such submitted information, are stored a database 1716. They are then also then preferably accessed by NLP engine 1708 and/or by blockchain API 1710. Optionally database 1716 also features information about available resources. Also optionally database 1716 and evidence storage 1714 are combined to a single entity or storage (not shown).

Optionally an API 1722 provides a gateway to server 1706.

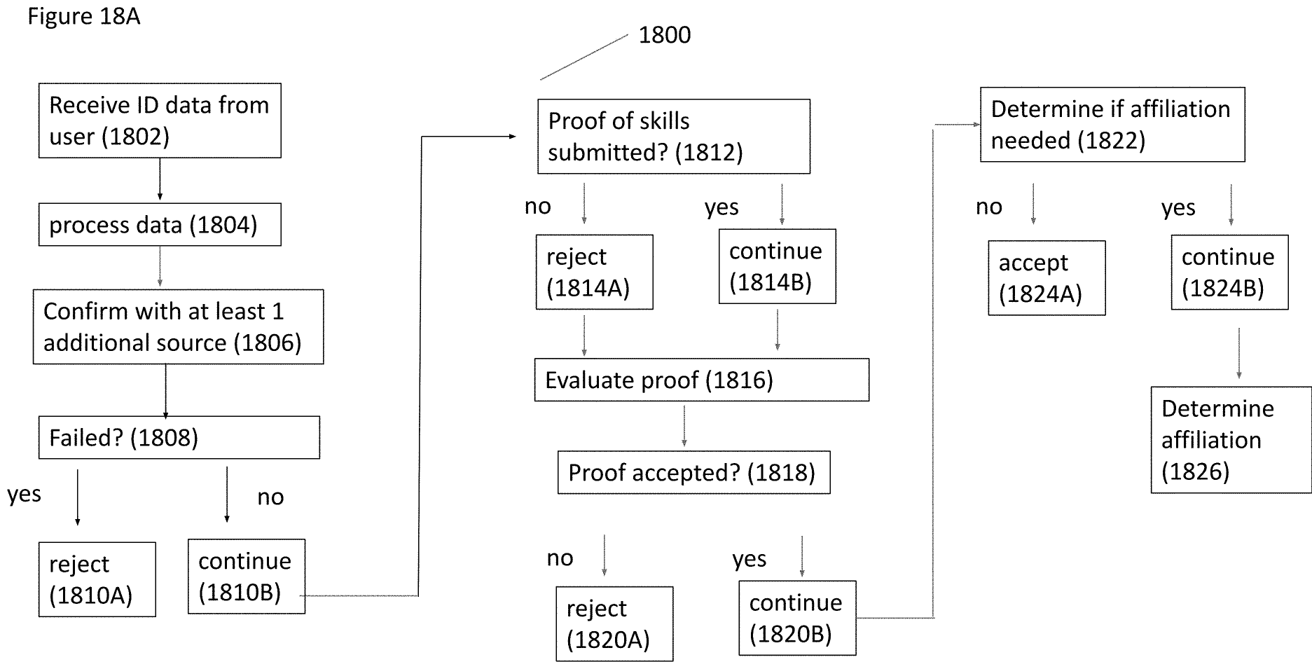

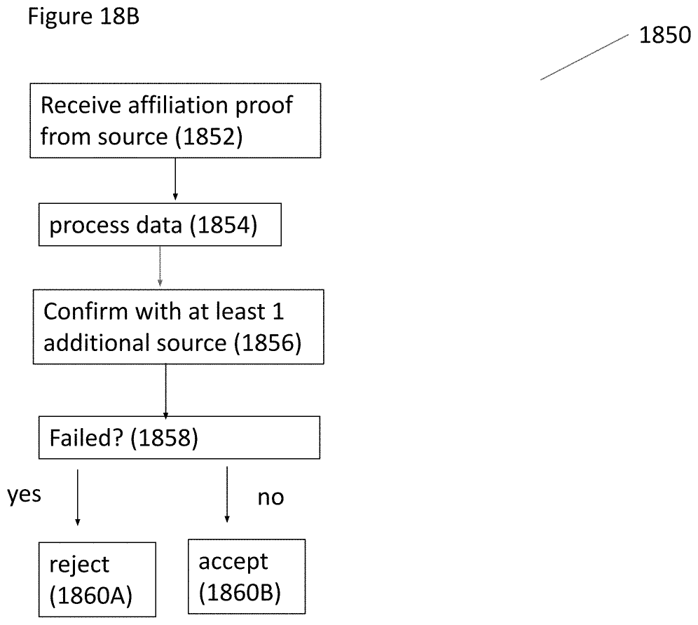

FIGS. 18A and 18B related to non-limiting, exemplary methods for user verification. FIG. 18A shows a non-limiting, exemplary method for verifying user identification and optionally also skills and affiliation. As shown in a method 1800, user identification information is received from the user at 1802. This information may include any suitable user identification, including but not limited to digital credentials or identification, photos of physical credentials or identification, biometric data, credentials available from an authority or credentials available through a system as described herein. Next the identification data is processed at 1804. At least one additional form of user identification information is received from at least one additional source at 1806. Preferably this source differs from the source(s) for information provided at 1802. The processed data is then compared to the information from at least one additional source at 1808. If the comparison fails, or if no information is received from at least one additional source, then the user is rejected at 1810A. Otherwise, the process continues at 1810B.

The user may be asked to provide proof of skills if required, for example for a job application, to be admitted to an educational institution or for other reasons. Such a proof may relate to a portfolio of work, verified previous jobs performed, licensing for a regulated profession (including without limitation medical, legal, financial and other regulated professions) and the like. If the user is asked to provide such a proof of skills, then they are submitted at 1812. If proof of skills is not submitted and it is required, then the user is rejected at 1814A. Otherwise the process continues at 1814B.

The proof which the user provides is then evaluated at 1816. Based on such an evaluation, which may also optionally include verification of the accuracy of the information, then it is determined whether the proof is acceptable at 1818. If the proof is not acceptable, then the user is rejected at 1820A. Otherwise, the process continues at 1820B.

The process then preferably determines whether proof of affiliation is required at 1822. If no proof of affiliation is required, then the user is accepted and the process ends at 1824A. Otherwise, the process continues at 1824B. The user's affiliation is then determined and verified at 1826, for example as described with regard to FIG. 18B.

FIG. 18B shows a non-limiting, exemplary method for verifying user affiliation. As shown in a method 1850, an affiliation proof is received from a source at 1852. The data associated with that proof is then processed at 1854, which may for example include confirming the affiliation with the source. At 1856, the affiliation is preferably confirmed with at least one other source. If the verification of the affiliation fails as determined at 1858, then the user is rejected at 1860A. Otherwise the user is accepted at 1860B.

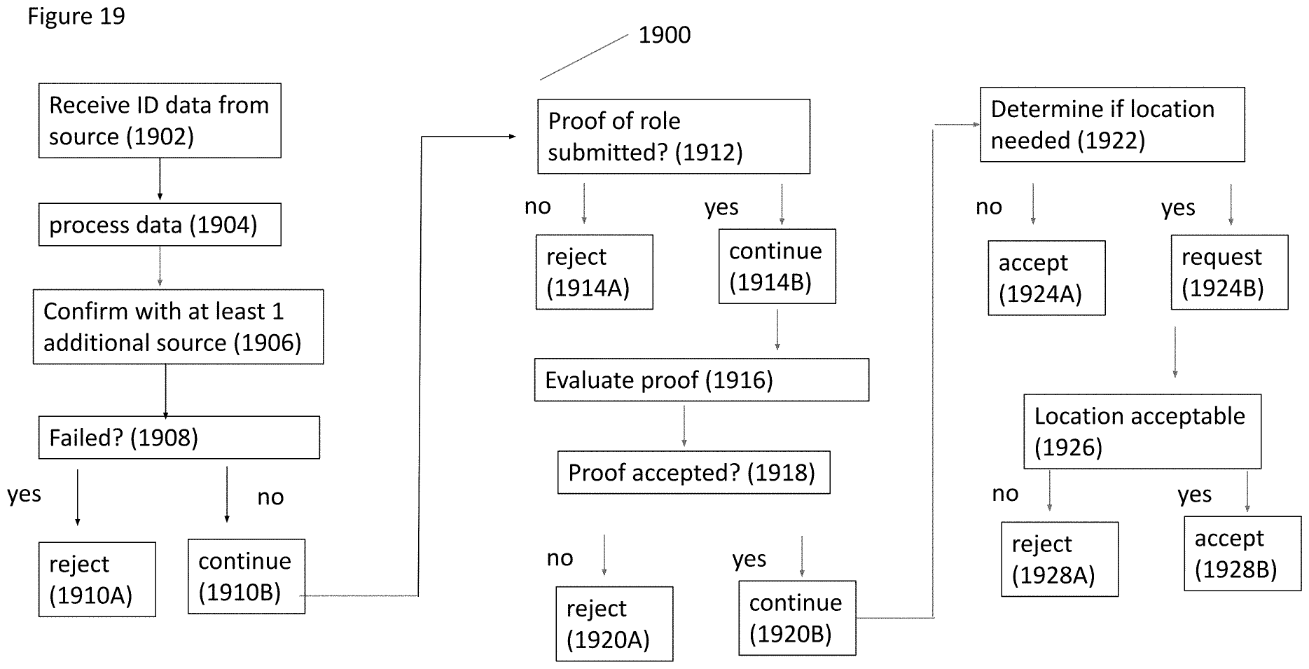

FIG. 19 relates to a non-limiting, exemplary method for user role verification. As shown in a method 1900, stages 1902-1910A/B optionally and preferably are performed as described with regard to FIG. 18A. Next, at 1912, the user is requested to submit a proof of role, the submission of which is then verified. Such a role may include but is not limited to a whistleblower with inside information, an informant, a witness, or any physically present individual providing a report. Optionally the user may be identified as a trusted source, such as for example and without limitation a first responder, an authorized journalist, a user who has a trust credential within the system, or a member of another authority. Another category may be those who do not wish to be identified but may still wish to participate in an activity, such as those individuals involved in protests and protest art, or other such activism; healthcare research; crowdsourcing; product safety and provenance or origin tracing; covert operations; pseudonymous data analysis; risk reduction for online communication and reputation; and bounty and reward systems. If the user does not submit proof of their role, then they are rejected at 1914A. Otherwise, the process continues at 1914B.

The proof is evaluated at 1916, which may include for example verification with the source of the proof or through verification with another source. It is then determined at 1918 whether the proof is acceptable. If it is not acceptable, then the user is rejected at 1920A. Otherwise, the process continues at 1920B.

Optionally, the location of the user may be required at 1922. If the location of the user is not required, then the user is accepted at 1924A. Otherwise, the location is requested at 1924B. At 1926, it is determined whether the location of the user is acceptable. For example, if the user is acting as a witness to a physical event, then the user may be required to be located within a geographical area. If the user is a witness to a physical event, whistleblower or insider, then the user may be required to be located within a geofenced area, or may be required to have a location history that shows that the user was within that geofenced area. If the location is acceptable, then the user is accepted at 1928B; otherwise the user is rejected at 1928A.

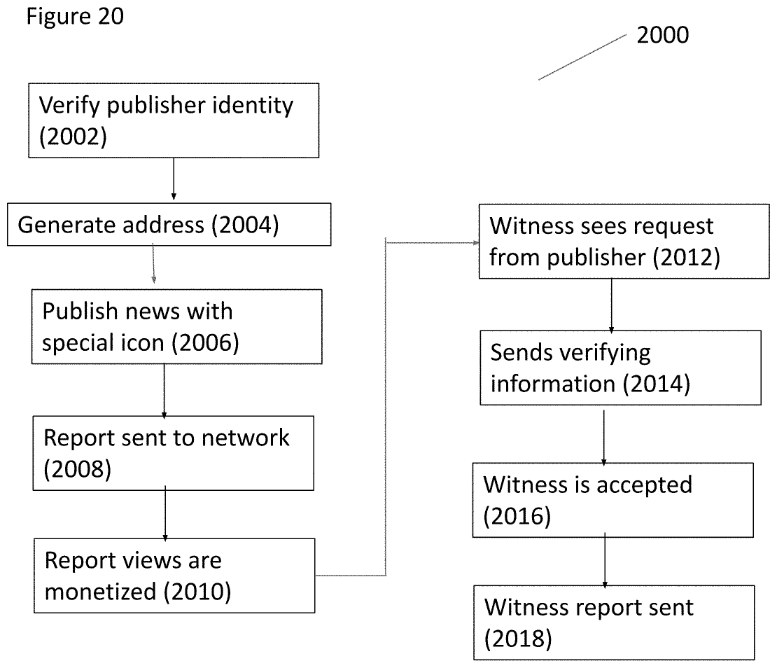

FIG. 20 relates to a non-limiting, exemplary method for publisher operation with verification. As shown in a method 2000, the method starts by verifying the publisher identity at 2002. This identity may relate to a known publishing entity, such as a known newspaper, news magazine, television or radio news broadcaster, or online news entity; or a new publishing entity that may not be known. Verification may be performed through verifying the publisher itself and/or by verifying one or more representatives of that publisher, such as one or more journalists.

Next the publisher wallet address is generated at 2004, so that the publisher wallet exists on the blockchain. The publisher wallet is then associated with the verified publisher, which is able to control access to that wallet.

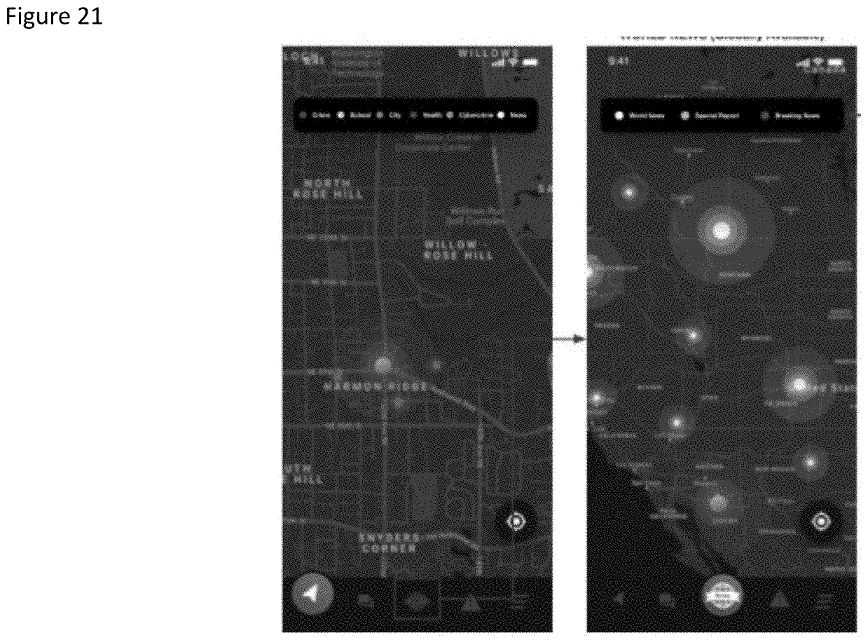

News and reports from this publisher are preferably published with a special icon or other indicator, for example as shown with regard to the screenshot in FIG. 21, at 2006. This indicator enables followers of this publisher to identify the associated news or report. The publisher may then choose to send a report (or optionally news) to the entire network or only to its followers at 2008. Users who then view the news or report may then pay for it, either before or after viewing, so as to enable the publisher to monetize this publication, at 2010. Payment is preferably made through the user wallet and blockchain as described herein; payment is then received by the publisher wallet. Payments may be in the form of micropayments, for example.

A potential witness or other informant may view a request from the publisher through the app or a chatbot as described herein, at 2012. The witness sends verifying information, for example as described herein, at 2014. The witness is accepted at 2016 and the witness report is sent at 2018. The report may for example include chat, voice communication, asynchronous messaging and the like, or even may be performed through an in-person meeting. Optionally the wallet address of the user is credited in the reporting of the story; also optionally the status of the user may be increased, as having provided verifiable information for the reporting.

FIG. 21 shows a non-limiting, exemplary screenshot for news publication. For example, the left hand panel shows user reports of events and incidents on a map. If the user clicks the button indicated by the red square, then the right hand panel is displayed, with verified publisher reports and news, as shown by the red arrow.

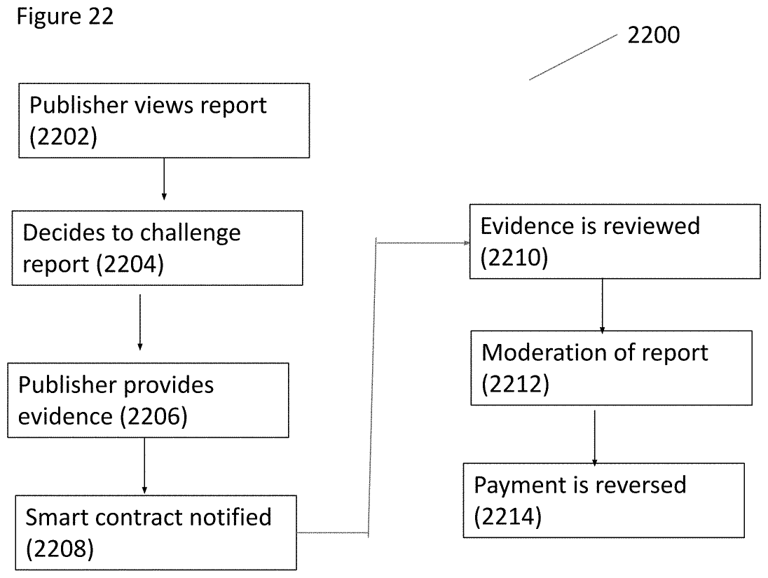

FIG. 22 relates to a non-limiting, exemplary method for challenging a report by a publisher or other corporate citizen. This method enables publishers or other corporate citizens to challenge false information, while also providing a route for further verification of information. As shown in a method 2200, the process starts at 2202, when the publisher or corporate citizen views the report. It then decides to challenge the report at 2204. The publisher or corporate citizen provides evidence to support this challenge at 2206. The smart contract which relayed any payments, or status or history information, for association with the user wallet, is notified of the challenge at 2208. For example, the smart contract may comprise a plurality of smart contracts, in which a smart contract could relay payment to wallets while another smart contract would act as a escrow, and yet another smart contract may handle the challenge. If the challenge is successful, then optionally payment, or status or history information, would not be moved from escrow to the user wallet. Alternatively, if already associated with the user wallet, then it could be removed.

At 2210, the evidence is reviewed, for example as described herein. If the challenge is considered to be successful, then at 2212 the report or news is moderated, for example by blocking or reversing payment at 2214. The report or news may also be republished in the corrected or moderated version.

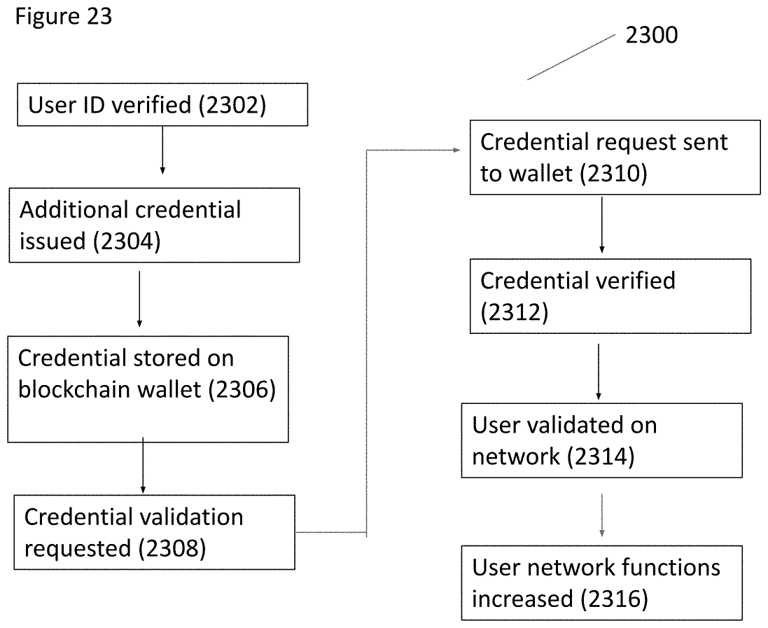

FIG. 23 relates to a non-limiting, exemplary method for user verification and credentialing. As shown in a method 2300, the identity of the user who is associated with a particular user wallet is verified, for example as described herein. Additional credential is then preferably issued at 2304, for example according to the verification of the user's identity. At 2306, the additional credential is stored on a blockchain and is preferably associated with the user's wallet. The user or other entity may request a credential validation at 2308. The user may request such a validation as the user may need to trigger the process, given that the user may have only a pseudonymous association through the wallet. As described herein, preferably such a pseudonymous association enables the activities of the user to be tracked while still maintaining privacy. The blockchain wallet may be identified through a pseudonym which is trackable through multiple transactions, while still preserving the privacy of the user associated with the wallet (for example, by keeping the name and other contact details of the user private). Optionally a separate credentials wallet is provided on the blockchain, as a user credentials wallet, such that the credentials would be stored in a separate wallet than the user wallet as described herein. Optionally the user wallet would have a separate tag or other indicator that would indicate that the user also has credentials on the user credential wallet. The separate tag or other indicator may be related to a trust score that is associated with the user credential wallet. Optionally the user wallet would not enable a direct identification of the user credential wallet.

At 2310, the credential request is sent to the credentials wallet. The credential request is then verified at 2312, for example by a separate connecting authority or through an extra server. Optionally the credential verification occurs without verifying the identity of the user associated with the user credentials wallet, for example through a zero knowledge proof. Optionally, such a verification process may be used for automatically blocking access to such credentials, for example in the case of a hacking attack, death of the associated user and so forth. At 2314, the user is validated, for example on the network or to another entity. If validated on the network, preferably the user's functions and available actions are increased at 2316.

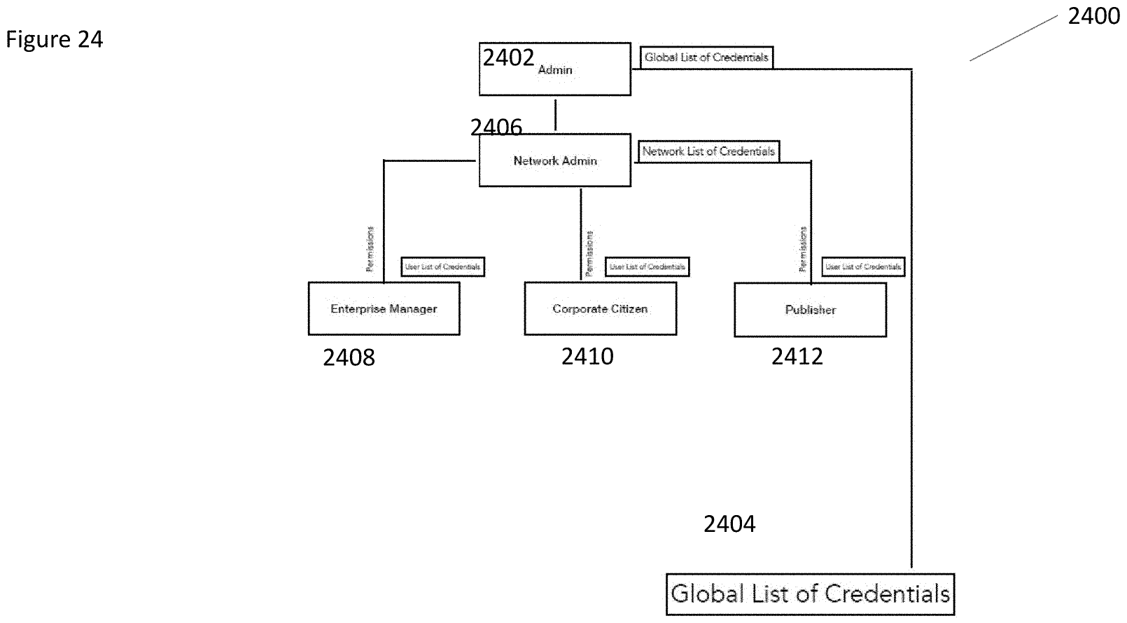

FIG. 24 relates to a non-limiting, exemplary system for global credentials. As shown in a system 2400, a global admin platform 2402 is able to administer credentials globally, shown as global credentials 2404. Optionally all credentials are stored within global credentials 2404, but access is preferably only provided to authorized entities.

Specific sets of credentials may be divided into groups, such as for a particular blockchain crowdsourced information network, shown as network credentials that are administered by a network admin platform 2406. Optionally different networks may be provided with different sets of credentials, which are administered through various network admin platforms 2406. Provision of such credentials to, and/or access by, may be provided to an enterprise manager 2408, a corporate citizen 2410, or a publisher 2412. However, if publisher 2412 for example revokes an associated credential of an individual, then preferably that credential is revoked across the network, for example at global credentials 2404, so that the associated credential can no longer used in any network.

To support such global credentials 2404, preferably each network admin platform 2406 comprises a secure bridge, for example as a VPN (virtual private network) or a private cloud. Preferably the secure bridge comprises both public-facing and hence internet-accessible cloud storage, and also cloud storage that is not internet-accessible. The secure bridge contains ZK (zero knowledge) Proofs to run checks against public accounts to determine if the purported user who wants to store their credentials or qualifications is actually a bot. The secure bridge may also check “attributes” that get assigned to the user, such as for example whether they have a verified social media account. The attribute may be added to the public key as an attribute. Another ZK Proof (ZKP could check for regular posts on social media.

Optionally, the user can also add attributes of “country of origin” and a third party ZKP may be used to confirm. The more attributes the login user has, the greater trust and reputation score which will increase the likelihood that their communication will have a higher confidence level and credibility. The secure bridge may also perform reputation scoring, for example in which the smart contracts are deployed to check reports against third party data, and assign more trust scores and verification of reports. Optionally the secure bridge is able to provide information about verified user credentials and qualifications. Also optionally the secure bridge is able to provide reward payments as described herein.

Optionally permissions are controlled at the secure bridge in terms of what is shared with public network and private networks. (eg. healthcare private network only sees healthcare related reporting and OSINT (open source intelligence).

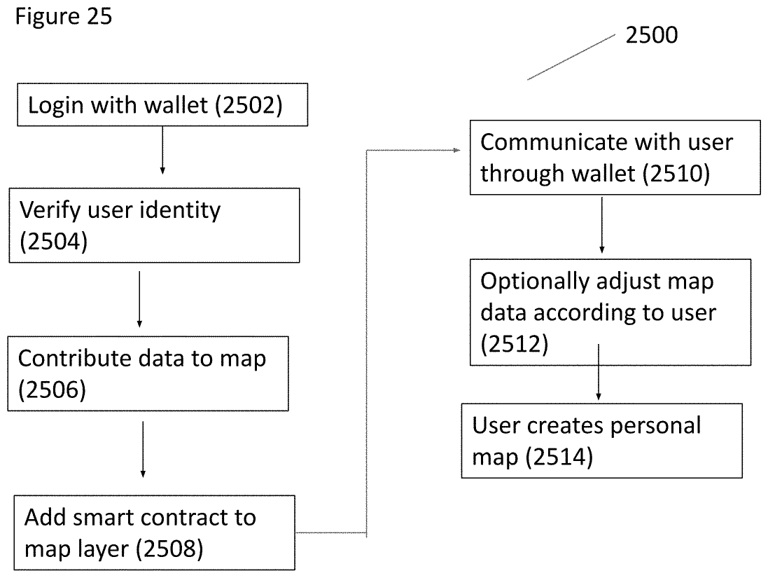

FIG. 25 relates to a non-limiting, exemplary method for map creation. As shown with regard to a method 2500, the process begins at 2502 when the user logs in through their wallet and hence through their wallet identifier. Such a process may be performed for example through MetaMask or another wallet management tool. As previously described, the wallet identifier is preferably pseudonymous, such that the transactions involving the user through that wallet may be tracked, while still preserving the privacy of the user.

At 2504, the identity of the user is verified through the wallet. Optionally, a particular connection to an organization, such as a company, government department, non-profit organization and so forth, is also verified. Other verifications such as expertise and the like may also be determined. Optionally such an additional authentication is performed using ZKP (zero knowledge proof).

At 2506, the user locates a particular map of interest and contributes data to that map. Alternatively, data is contributed according to a certain category and then one or more maps are suggested to the user, as requesting such contributions. Optionally the data is collected through direct interaction with the map, or alternatively through another type of connection, such as for example a chatbot.

At 2508, a smart contract may be added to the map overall and/or to a particular map layer. These map layers also are smart contracts which can be set to trigger actions based on use cases (eg. crime stoppers reward for data that is used in criminal cases), with for example a reward or other value sent directly to the wallet address for the wallet of the user who provided such data. Every data addition may contain a digital signature and/or be invoked as a transaction. Optionally each layer of the map has one or more smart contracts with different criteria for providing a reward.

At 2510, optionally an email or other communication may be sent to the user through the wallet, for example according to the wallet address. For example, such communication may be made to ask an additional or follow-up question according to the data that is input. Such communication may be made through an app associated with the wallet address, so that the user is able to send and receive emails or other messages through the app.

At 2512, the map data may be adjusted according to the user, such that the data may be given greater or lesser weight according to the identity and/or reputation of the user, for example.

At 2514, the user may create a personal map. For example and without limitation, a user is able to generate their own “decentralized open maps” to embed onto their websites or create subdomains that can be put on a decentralized domain. Preferably the map is created with data collection tools to protect that site from being removed and the data from being tampered with.

Such a user is able to customize the smart contracts to engage their populations, incentivize participation, and execute processes that reward users for contributing to the map data.

The above structure enables smart contracts to be layered into the maps themselves so they can be used for effective crowdsourcing of data in a myriad of situations, non-limiting examples of which include crime maps, protest maps, business data collection, experience reports, internet outage reports, water quality reports, wild animal mapping, and so forth. Pseudonymous tracking both preserves user privacy, and also enables users with a greater reputation and/or expertise to be given a greater reward and/or to have their data otherwise given greater weight. This combination provides an open, secure, data mapping input mechanism that can incentivize participation while maintaining a pseudonymous approach to the collection process. Without wishing to be limited by a closed list, such an approach increases security, removes barriers to entry, decentralizes participation, separates the “value” captured by the user directly to their wallet, a censorship resistant way of capturing data inputs for any topic, and also enabling a data validation process to take place prior to any personal attacks to depreciate the value of that data, while still maintaining a “connection” to the reporting history of that wallet address for further chain analysis and reputation scoring.

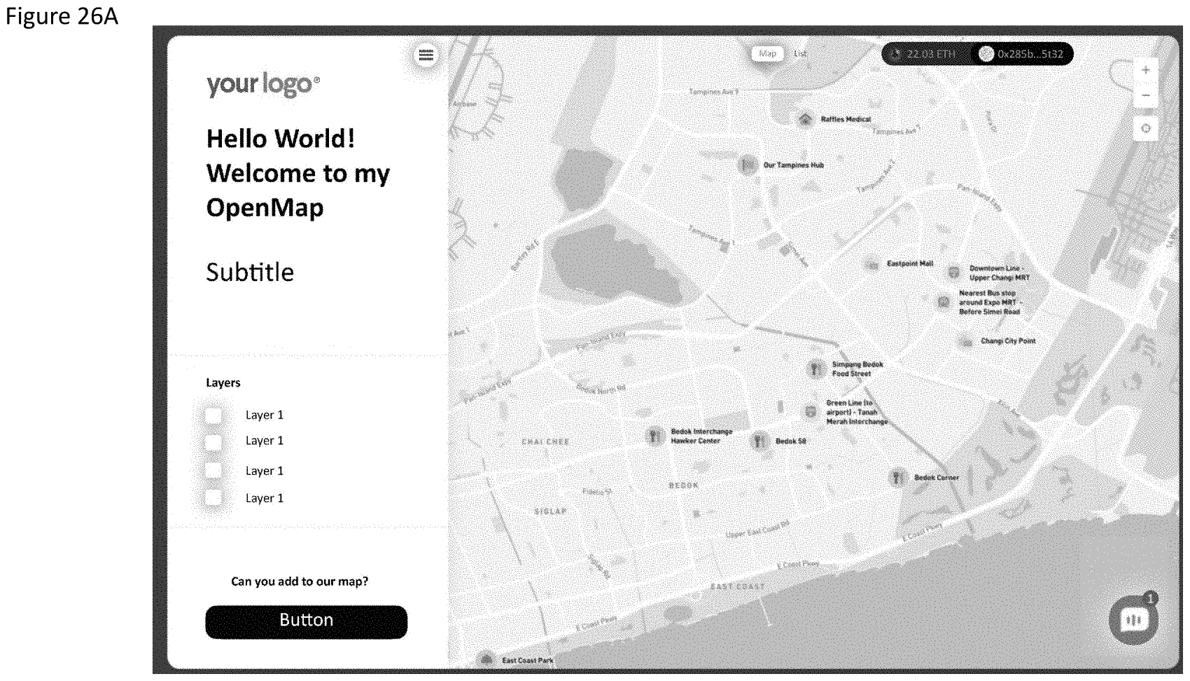

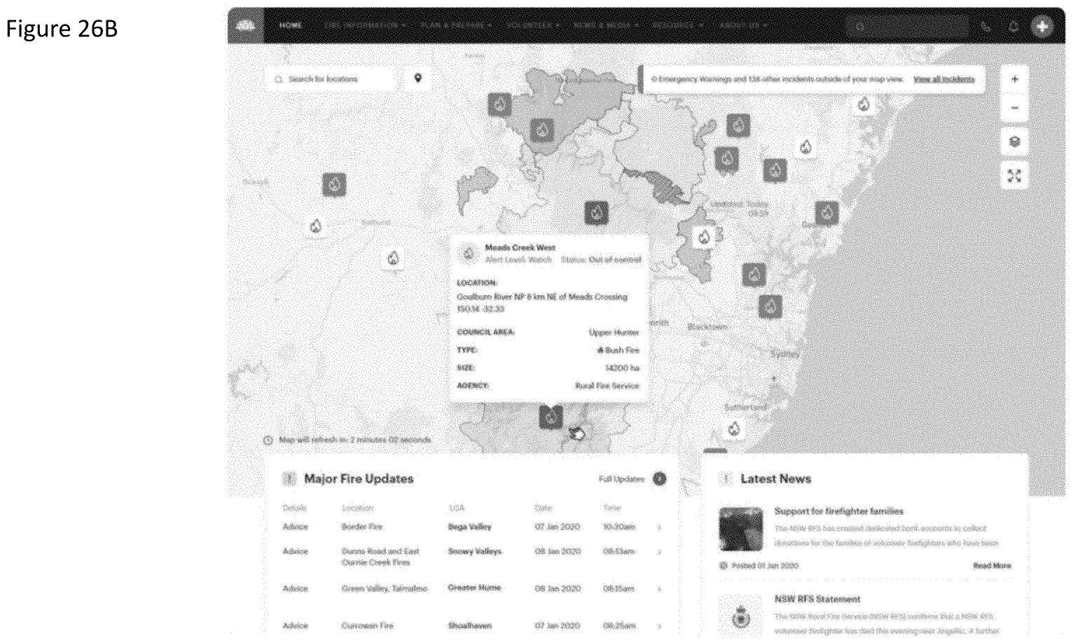

FIGS. 26A and 26B relate to two non-limiting examples of maps, created according to the method of FIG. 25. FIG. 26A shows a map after personalization by the user viewing that map and FIG. 26B shows another non-limiting example of such a map.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for determining a qualification for a user, comprising a plurality of user computational devices, each user computational device comprising a user app; a server, comprising a server interface and an AI (artificial intelligence) engine; a blockchain for storing user qualification information; and a computer network for connecting said user computational devices and said server; wherein information about the qualification is provided through each user app and is analyzed by said AI engine, wherein said AI engine determines whether said user qualification is valid and stores said user qualification on said blockchain.

2. The system of claim 1, wherein said server comprises a server processor and a server memory, wherein said server memory stores a defined native instruction set of codes; wherein said server processor is configured to perform a defined set of basic operations in response to receiving a corresponding basic instruction selected from said defined native instruction set of codes; wherein said server comprises a first set of machine codes selected from the native instruction set for receiving said user qualification information from said user computational device, and a second set of machine codes selected from the native instruction set for executing functions of said AI engine.

3. The system of claim 2, wherein each user computational device comprises a user processor and a user memory, wherein said user memory stores a defined native instruction set of codes; wherein said user processor is configured to perform a defined set of basic operations in response to receiving a corresponding basic instruction selected from said defined native instruction set of codes; wherein said user computational device comprises a first set of machine codes selected from the native instruction set for receiving said user qualification information through said user app, a second set of machine codes selected from the native instruction set for transmitting said information to said server as said request, a third set of machine codes selected from the native instruction set for determining whether said user qualification is valid and a fourth set of machine codes selected from the native instruction set for storing said user qualification on said blockchain.

4. The system of claim 1, wherein said server receives a request for said user qualification information from another user computational device and provides said user qualification information in response, along with an indication as to whether said user qualification is valid.

5. The system of claim 1, further comprising a user wallet for providing access to said user qualification information, wherein said user wallet accesses said stored user qualification information on said blockchain.

6. The system of claim 1, wherein said AI engine comprises deep learning and/or machine learning algorithms.

7. The system of claim 6, wherein said AI engine comprises an algorithm selected from the group consisting of word2vec, a DBN, a CNN and an RNN.

8. The system of claim 1, wherein said request is received in a form of a document, further comprising a tokenizer for tokenizing the document into a plurality of tokens, and a machine learning algorithm for analyzing said tokens to determine a request intent contained in said document.

9. The system of claim 8, wherein said AI engine compares said tokens to desired information, to determine said quality of information.

10. The system of claim 1, wherein each user app is associated with a unique user identifier and wherein said AI engine associates said user qualification information received through said user app according to said unique user identifier, including with regard to information previously received according to said unique user identifier.

11. The system of claim 10, wherein said user computational device comprises a mobile communication device and wherein said unique user identifier identifies said mobile communication device.

12. The system of claim 1, further comprising a user wallet for providing a pseudonym for identifying an associated user, wherein a user contributes data according to said user wallet.

13. The system of claim 12, further comprising a smart contract that is invoked according to said data provided by said user and according to said pseudonym, wherein said pseudonym is associated with a quality identifier of the user, wherein said quality identifier is selected from the group consisting of a qualification of the user, an expertise of the user and an associated organization of the user.

14. The system of claim 13, wherein said server further comprises a map module for creating a map, wherein the user supplies data through computational communication with said map module according to an identity associated with said wallet.

15. The system of claim 14, wherein said map comprises a plurality of layers and wherein each layer is associated with a smart contract for providing a reward according to said supplied data.

16. The system of claim 14, wherein said computational communication comprises direct upload of data to said map module or communication with a chatbot, or a combination thereof.
